(19) United States
(12) Patent Application Publication
(10) Pub. No.: US 2008/0319015 A1
(43) Pub. Date: Dec. 25, 2008

(54) Insect Repellent Mixture

(76) Inventors: Hans-Werner Gruenewald, Reinheim (DE); Alexandra Axt, Rossdorf (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/158,355

(22) PCT Filed: Nov. 24, 2006
(86) PCT No.: PCT/EP2006/011310

§ 371 Date: Jun. 20, 2008

Related U.S. Application Data
(60) Provisional application No. 60/752,371, filed on Dec. 22, 2005.

(51) Int. Cl. A01N 43/40; A01N 37/18; A01N 43/08; A01N 37/00; A01P 17/00

(52) U.S. Cl. 514/315; 514/617; 514/461; 514/625; 514/616; 514/561

(57) ABSTRACT

The present invention relates to the use of an insect repellent, preferably selected from the group 2-(2-hydroxyethyl)-1-methylpropyl 1-piperidinecarboxylate, N,N-diethyl-3-methylbenzamide, dimethyl phthalate, butopyronoxyl, 2,3,4,5-bis(2-butylene)-tetrahydro-2-furaldehyde, N,N-diethylcaprylamide, N,N-diethylbenzamide, o-chloro-N,N-diethylbenzamide, dimethyl carbate, di-n-propyl isocinchomeronate, 2-ethylhexane-1,3-diol, N-octylbicycloheptenedicarboximide or piperonyl butoxide, particularly preferably 2-(2-hydroxyethyl)-1-methylpropyl 1-piperidinecarboxylate, as action enhancer for a second insect repellent, to corresponding compositions, and to the preparation thereof.

The present invention relates to the use of an insect repellent, preferably selected from the group 2-(2-hydroxyethyl)-1-methylpropyl 1-piperidinecarboxylate, N,N-diethyl-3-methylbenzamide, dimethyl phthalate, butopyronoxyl, 2,3,4,5-bis(2-butylene)tetrahydro-2-furaldehyde, N,N-diethylcaprylamide, N,N-diethylbenzamide, o-chloro-N,N-diethylbenzamide, dimethyl carbate, di-n-propyl isocinchomeronate, 2-ethylhexane-1,3-diol, N-octylbicycloheptenedicarboximide or piperonyl butoxide, particularly preferably 2-(2-hydroxyethyl)-1-methylpropyl 1-piperidinecarboxylate, as action enhancer for a second insect repellent, to corresponding compositions, and to the preparation thereof.

A multiplicity of mosquitoes, horseflies, fleas, lice, bugs and ticks and mites, summarised below under the collective terms insects and spiders—or for simplification even under the generic term insects, which is used incorrectly in the biological sense—feed on the blood of mammals, which also include humans. They bore their way into the skin of their victims with their piercing and sucking tools until they hit blood vessels. During feeding, they secrete vessel-dilating and anticoagulant agents which can result in itching, hive formation and allergic reactions in the host. In particular in the tropics and subtropics, there is in addition a risk of infection with pathogens. Thus, for example, malaria is transmitted by the Anopheles mosquito or yellow fever is transmitted by the yellow fever mosquito. In temperate regions too, there is a risk of infections with pathogens transmitted by insects, such as, for example, tick-borne encephalitis transmitted by tick bite.

Protection against annoyance by insects and spiders is offered by so-called insect repellents. These are taken to mean a number of active substances which have a repellent effect on insects and spiders due to their odour. They are generally low-volatility compounds which evaporate slowly on the skin and thus form a scent pall above the skin which drives away the insects.

The commonest insect repellents include N,N-diethyl-3-methylbenzamide (“DEET”), which is active against mosquitoes, stable and sand flies, horseflies, fleas, bugs, ticks and mites. Furthermore, dimethyl phthalate (trade name: Palatinol® M, DMP) is employed against mosquitoes, lice, ticks and mites. Ethyl 3-(N-n-butyl-N-acetylamino)propionate (available from Merck, Darmstadt, Germany, under the trade name IR3535), which can be employed, for example, against mosquitoes, tsetse flies and horseflies, is particularly effective.

Most insect repellent active ingredients belong to the substance classes of the amides, alcohols, esters and ethers. Insect repellent active ingredients are usually intended to meet the following conditions: they must not evaporate too quickly and must not penetrate into the skin. They must have neither a primarily irritant nor sensitising action on the skin and should in addition be non-toxic. Their efficacy must also be retained on exposure to skin fluid and/or UV radiation.

Although these compounds, such as, in particular, ethyl 3-(N-n-butyl-N-acetylamino)propionate, have been classified as having no health risk, it is, however, desirable for the action of the insect repellents to be enhanced by additives and the use of smaller amounts of insect repellent in the formulation thus to be facilitated.

Surprisingly, it has now been found that an insect repellent, preferably selected from the group 2-(2-hydroxyethyl)-1-methylpropyl 1-piperidinecarboxylate, N,N-diethyl-3-methylbenzamide, dimethyl phthalate, butopyronoxyl, 2,3,4,5-bis(2-butylene)tetrahydro-2-furaldehyde, N,N-diethylcaprylamide, N,N-diethylbenzamide, o-chloro-N,N-diethylbenzamide, dimethyl carbate, di-n-propyl isocinchomeronate, 2-ethylhexane-1,3-diol, N-octylbicycloheptenedicarboximide or piperonyl butoxide, particularly preferably 2-(2-hydroxyethyl)-1-methylpropyl 1-piperidinecarboxylate, can serve as action enhancer for at least one second insect repellent.

The present invention therefore relates firstly to the use of an insect repellent, preferably selected from the group 2-(2-hydroxyethyl)-1-methylpropyl 1-piperidinecarboxylate, N,N-diethyl-3-methylbenzamide, dimethyl phthalate, butopyronoxyl, 2,3,4,5-bis(2-butylene)tetrahydro-2-furaldehyde, N,N-diethylcaprylamide, N,N-diethylbenzamide, o-chloro-N,N-diethylbenzamide, dimethyl carbate, di-n-propyl isocinchomeronate, 2-ethylhexane-1,3-diol, N-octylbicycloheptenedicarboximide or piperonyl butoxide, particularly preferably 2-(2-hydroxyethyl)-1-methylpropyl 1-piperidinecarboxylate, as action enhancer for at least one second insect repellent.

2-(2-Hydroxyethyl)-1-methylpropyl 1-piperidinecarboxylate is known as an insect repellent and is commercially available, for example under the name Bayrepel® from Lanxess (INCI: icaridin or picaridin; IUPAC: 1-piperidinecarboxylic acid 2-(2-hydroxyethyl)-1-methylpropyl ester; CAS No. is 119515-38-7).

Insect repellents which are suitable for mixing with an action enhancer, as described above, are, for example, compounds of the formula I

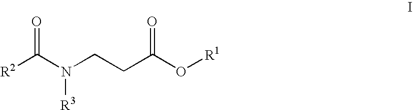

where R¹, R² and R³ may be identical or different and are selected from
straight-chain or branched C₁- to C₂₄-alkyl groups,
straight-chain or branched C₃- to C₂₄-alkenyl groups,
straight-chain or branched C₁- to C₂₄-hydroxyalkyl groups, where the hydroxyl group may be bonded to a primary or secondary carbon atom of the chain and furthermore the alkyl chain may also be interrupted by oxygen, and/or
C₃- to C₁₀-cycloalkyl groups and/or C₃- to C₁₂-cycloalkenyl groups, where the rings may in each case also be bridged by —(CH₂)ₙ— groups, where n=1 to 3.

The compounds of the formula I are known from the literature:
Ethyl 3-(acetylbutylamino)propionate (synonymous with ethyl 3-(N-n-butyl-N-acetylamino)propionate) is a known insect repellent which is marketed by Merck under the trade name IR3535®.
The suitability of further β-alanine derivatives as insect repellents is investigated in M. Klier, F. Kuhlow, J. Soc. Cos. Chem., 27, pp. 141-153 (1976).
WO 2005/074897 describes numerous compounds of the formula I and the preparation thereof.

It has been found that compounds in which R¹ and R³ may be identical or different and are selected from ethyl, n-propyl, isopropyl, n-butyl, isobutyl, tert-butyl, n-pentyl, n-hexyl, n-heptyl, n-octyl, 2-ethylhexyl, n-decyl, n-dodecyl, n-tetradecane, n-hexadecane, n-octadecane, n-eicosane, n-docosane and n-tetracanel, where R¹ preferably stands for 2-ethylhexyl and/or R³ preferably stands for n-octyl, 2-ethylhexyl, n-decyl or n-dodecyl, are particularly suitable for the use according to the invention.

Preference is also given in accordance with the invention to the use of compounds in which R² is selected from the group comprising the elements methyl, n-propyl, isopropyl, n-pentyl, n-heptyl, 1-ethylpentyl, n-nonyl, n-undecyl, where R² is preferably selected from the group comprising the elements methyl, 1-ethyl-pentyl, n-nonyl and n-undecyl.

Specifically, the compounds listed below have proven particularly suitable for the use according to the invention:
ethyl N-acetyl-N-(2-ethylhexyl)-3-aminopropanoate,
ethyl N-acetyl-N-(dodecyl)-3-aminopropanoate,
ethyl N-(2-ethylhexoyl)-N-(butyl)-3-aminopropanoate,
butyl N-acetyl-N-(butyl)-3-aminopropanoate,
ethyl N-(2-ethylhexoyl)-N-(2-ethylhexyl)-3-aminopropanoate,
ethyl N-(2-ethylhexoyl)-N-(dodecyl)-3-aminopropanoate,
butyl N-acetyl-N-(2-ethylhexyl)-3-aminopropanoate,
butyl N-acetyl-N-(dodecyl)-3-aminopropanoate,
butyl N-(2-ethylhexoyl)-N-(butyl)-3-aminopropanoate,
butyl N-(2-ethylhexoyl)-N-(2-ethylhexyl)-3-aminopropanoate,
butyl N-(2-ethylhexoyl)-N-(dodecyl)-3-aminopropanoate,
2-ethylhexyl N-acetyl-N-(butyl)-3-aminopropanoate,
2-ethylhexyl N-acetyl-N-(2-ethylhexyl)-3-aminopropanoate,
2-ethylhexyl N-acetyl-N-(dodecyl)-3-aminopropanoate,
2-ethylhexyl N-(2-ethylhexoyl)-N-(butyl)-3-aminopropanoate,
2-ethylhexyl N-(2-ethylhexoyl)-N-(2-ethylhexyl)-3-aminopropanoate,
2-ethylhexyl N-(2-ethylhexoyl)-N-(dodecyl)-3-aminopropanoate.

The corresponding compounds of the formula I and the preparation thereof are described in WO 2005/074897, the corresponding disclosure content of which expressly also belongs to the subject-matter of the present application.

In a very particular manner, ethyl 3-(acetylbutylamino)propionate is suitable as second insect repellent for the use according to the invention, in particular together with the action enhancer 2-(2-hydroxyethyl)-1-methylpropyl 1-piperidinecarboxylate. For the combination of these said insect repellents and a corresponding composition comprising these two insect repellents, no further insect repellent as described above is furthermore preferably present.

The preferred insect repellents as second insect repellent may furthermore be selected, naturally depending on the insect repellent as action enhancer, from N,N-diethyl-3-methylbenzamide, dimethyl phthalate, butopyronoxyl, 2,3,4,5-bis(2-butylene)tetrahydro-2-furaldehyde, N,N-diethylcaprylamide, N,N-diethylbenzamide, o-chloro-N,N-diethylbenzamide, dimethyl carbate, di-n-propyl isocinchomeronate, 2-ethylhexane-1,3-diol, N-octylbicycloheptenedicarboximide, piperonyl butoxide, 2-(2-hydroxyethyl)-1-methylpropyl 1-piperidinecarboxylate or mixtures thereof, where at least one insect repellent is particularly preferably selected from N,N-diethyl-3-methylbenzamide, ethyl 3-(acetylbutylamino)propionate or mixtures thereof.

The present invention furthermore relates to compositions comprising 1 to 60% by weight of at least one second insect repellent and 0.1 to 20% by weight of the insect repellent as action enhancer, where the weight percent ratio of the at least second insect repellent to the action enhancer is in the range from 20:1 to 1:1.

The compositions according to the invention here are usually compositions which can be applied topically, for example cosmetic or dermatological formulations. In this case, the compositions comprise a cosmetically or dermatologically suitable vehicle and, depending on the desired property profile, optionally further suitable ingredients.

The compositions may comprise, essentially consist of or consist of the said necessary or optional constituents or restrictions. All compounds or components which can be used in the compositions are either known and commercially available or can be synthesised by known processes.

Preferred compositions comprise 2 to 50% by weight, preferably 5 to 30% by weight, particularly preferably 10 to 25% by weight, of at least one second insect repellent, as described above. Preferred compositions comprise 0.5 to 10% by weight, preferably a maximum of 5% by weight and particularly preferably a maximum of 3% by weight, of the insect repellent as action enhancer, as described above.

The weight percent ratio of the at least second insect repellent, as described above, to the action enhancer, as described above, is preferably in the range from 10:1 to 5:1 and equal to 1:1. The weight percent ratio is particularly preferably 9:1, 5:1 and/or 1:1.

The person skilled in the art has absolutely no difficulties in selecting the amounts correspondingly, depending on the intended action of the composition.

For the purposes of the present invention, the term formulation is used synonymously with the term composition.

The compositions according to the invention are available, for example, in the form of solutions, gels, sticks, rollers, pump sprays and aerosol sprays, with solutions and sprays forming the majority of the commercially available products. The basis for these two product forms are usually alcoholic or aqueous/alcoholic solutions with addition of fatting substances and slight perfuming. Although other composition forms, such as, in particular, emulsions, creams, ointments and the like, are in principle conceivable and desired, they have, however, to date in some cases proven difficult to formulate in a stable manner. Here too, the formulation assistants according to the invention can advantageously be employed.

The compositions here may comprise further active substances, preferably selected from the group of the organic UV filters, flavone derivatives, chromone derivatives, aryl oximes or parabens.

Parabens are 4-hydroxybenzoic acid esters, which are used in free form or as sodium salts for the preservation of compositions in the area of foods, cosmetics and medicaments. The action of the esters is directly proportional to the chain length of the alkyl radical, but conversely the solubility drops with increasing chain length. As non-dissociating compounds, the esters are substantially pH-independent and act in a pH range from 3.0-8.0. The antimicrobial action mechanism is based on damage of the microbe membranes by the surface activity of the PHB esters and on protein denaturing. In addition, interactions occur with coenzymes. The action is directed against fungi, yeasts and bacteria. The most important parabens as preservatives are methyl 4-hydroxybenzoate, ethyl 4-hydroxybenzoate, propyl 4-hydroxybenzoate, butyl 4-hydroxybenzoate. These compounds, often called only methyl-, ethyl-, propyl- and butylparaben, are only sparingly soluble in common vehicles for the compositions to be preserved. The use of the compounds of the formula I can therefore simplify the incorporation of parabens, in particular methyl 4-hydroxybenzoate, ethyl 4-hydroxybenzoate, propyl 4-hydroxybenzoate, butyl 4-hydroxybenzoate, into compositions.

Of the aryl oximes, which are likewise only sparingly soluble in conventional vehicles for cosmetic and dermatological compositions, preference is given to the use of 2-hydroxy-5-methyllaurophenone oxime, which is also known as HMLO, LPO or F5. Its suitability for use in cosmetic compositions is disclosed, for example, in DE-A-41 16 123. Compositions which comprise 2-hydroxy-5-methyllaurophenone oxime are accordingly suitable for the treatment of skin diseases which are accompanied by inflammation. It is known that compositions of this type can be used, for example, for the therapy of psoriasis, various forms of eczema, irritative and toxic dermatitis, UV dermatitis and further allergic and/or inflammatory diseases of the skin and skin appendages. Compositions according to the invention which comprise an aryl oxime, preferably 2-hydroxy-5-methyllaurophenone oxime, exhibit surprising anti-inflammatory suitability. The compositions here preferably comprise 0.01 to 10% by weight of the aryl oxime, it being particularly preferred for the composition to comprise 0.05 to 5% by weight of aryl oxime.

In accordance with the invention, flavone derivatives are taken to mean flavonoids and coumaranones. In accordance with the invention, flavonoids are taken to mean the glycosides of flavonones, flavones, 3-hydroxyflavones (=flavonols), aurones, isoflavones and rotenoids [Römpp Chemie Lexikon [Römpp's Lexicon of Chemistry], Volume 9, 1993]. For the purposes of the present invention, however, this term is also taken to mean the aglycones, i.e. the sugar-free constituents, and the derivatives of the flavonoids and aglycones. For the purposes of the present invention, the term flavonoid is furthermore also taken to mean anthocyanidine (cyanidine). For the purposes of the present invention, the term coumaranones is also taken to mean derivatives thereof.

Preferred flavonoids are derived from flavonones, flavones, 3-hydroxyflavones, aurones and isoflavones, in particular from flavonones, flavones, 3-hydroxyflavones and aurones.

The flavonoids are preferably selected from the following compounds: 4,6,3′,4′-tetrahydroxyaurone, quercetin, rutin, isoquercetin, eriodictyol, taxifolin, luteolin, trishydroxyethylquercetin (troxequercetin), trishydroxyethylrutin (troxerutin), trishydroxyethylisoquercetin (troxeisoquercetin), trishydroxyethylluteolin (troxeluteolin), α-glycosylrutin, tiliroside and the sulfates and phosphates thereof. Of the flavonoids, particular preference is given, as active substances according to the invention, to rutin, tiliroside, α-glycosylrutin and troxerutin.

Of the coumaranones, preference is given to 4,6,3′,4′-tetrahydroxybenzyl-coumaranone-3.

The term chromone derivatives is preferably taken to mean certain chromen-2-one derivatives which are suitable as active ingredients for the preventative treatment of human skin and human hair against ageing processes and harmful environmental influences. At the same time, they exhibit a low irritation potential for the skin, have a positive effect on water binding in the skin, maintain or increase the elasticity of the skin and thus promote smoothing of the skin. These compounds preferably conform to the formula IV

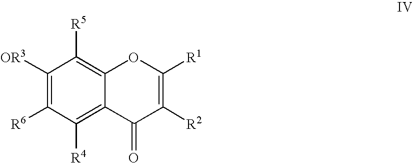

where
R¹ and R² may be identical or different and are selected from
H, —C(═O)—R⁷, —C(═O)—OR⁷,
straight-chain or branched C₁- to C₂₀-alkyl groups,
straight-chain or branched C₃- to C₂₀-alkenyl groups,
straight-chain or branched C₁- to C₂₀-hydroxyalkyl groups, where the hydroxyl group may be bonded to a primary or secondary carbon atom of the chain and furthermore the alkyl chain may also be interrupted by oxygen, and/or
C₃- to C₁₀-cycloalkyl groups and/or C₃- to C₁₂-cycloalkenyl groups, where the rings may in each case also be bridged by —(CH₂)ₙ— groups, where n=1 to 3,
   R³ stands for H or straight-chain or branched C₁- to C₂₀-alkyl groups,
   R⁴ stands for H or OR⁸,
   R⁵ and R⁶ may be identical or different and are selected from
—H, —OH,
straight-chain or branched C₁- to C₂₀-alkyl groups,
straight-chain or branched C₃- to C₂₀-alkenyl groups,
straight-chain or branched C₁- to C₂₀-hydroxyalkyl groups, where the hydroxyl group may be bonded to a primary or secondary carbon atom of the chain and furthermore the alkyl chain may also be interrupted by oxygen and
   R⁷ stands for H, straight-chain or branched C₁- to C₂₀-alkyl groups, a polyhydroxyl compound, such as preferably an ascorbic acid radical or glycosidic radicals, and
   R⁸ stands for H or straight-chain or branched C₁- to C₂₀-alkyl groups, where at least 2 of the substituents R¹, R², R⁴-R⁶ are not H or at least one substituent from R¹ and R² stands for —C(═O)—R⁷ or —C(═O)—OR⁷.

The proportion of one or more compounds selected from flavonoids, chromone derivatives and coumaranones in the composition according to the invention is preferably from 0.001 to 5% by weight, particularly preferably from 0.01 to 2% by weight, based on the composition as a whole.

Compositions which are particularly preferred in accordance with the invention also comprise UV filters. Particular preference is given to UV filters whose physiological acceptability has already been demonstrated. Both for UVA and UVB filters, there are many proven substances which are known from the specialist literature, for example

benzylidenecamphor derivatives, such as 3-(4′-methylbenzylidene)dl-camphor (for example Eusolex® 6300), 3-benzylidenecamphor (for example Mexoryl® SD), polymers of N-{(2 and 4)-[(2-oxoborn-3-ylidene)methyl]-benzyl}acrylamide (for example Mexoryl® SW), N,N,N-trimethyl-4-(2-oxoborn-3-ylidenemethyl)anilinium methylsulfate (for example Mexoryl® SK) or (2-oxoborn-3-ylidene)toluene-4-sulfonic acid (for example Mexoryl® SL),
benzoyl- or dibenzoylmethanes, such as 1-(4-tert-butylphenyl)-3-(4-methoxyphenyl)propane-1,3-dione (for example Eusolex® 9020) or 4-isopropyldibenzoylmethane (for example Eusolex® 8020),
benzophenones, such as 2-hydroxy-4-methoxybenzophenone (for example Eusolex® 4360) or 2-hydroxy-4-methoxybenzophenone-5-sulfonic acid and its sodium salt (for example Uvinul® MS-40),
methoxycinnamic acid esters, such as octyl methoxycinnamate (for example Eusolex® 2292), isopentyl 4-methoxycinnamate, for example as a mixture of the isomers (for example Neo Heliopan® E 1000),
salicylate derivatives, such as 2-ethylhexyl salicylate (for example Eusolex® OS), 4-isopropylbenzyl salicylate (for example Megasol®) or 3,3,5-trimethylcyclohexyl salicylate (for example Eusolex® HMS),
4-aminobenzoic acid and derivatives, such as 4-aminobenzoic acid, 2-ethylhexyl 4-(dimethylamino)benzoate (for example Eusolex® 6007), ethoxylated ethyl 4-aminobenzoate (for example Uvinul® P25),
phenylbenzimidazolesulfonic acids, such as 2-phenylbenzimidazole-5-sulfonic acid and the potassium, sodium and triethanolamine salts thereof (for example Eusolex® 232), 2,2-(1,4-phenylene)bisbenzimidazole-4,6-disulfonic acid and salts thereof (for example Neoheliopan® AP) or 2,2-(1,4-phenylene)bisbenzimidazole-6-sulfonic acid;
and further substances, such as
2-ethylhexyl 2-cyano-3,3-diphenylacrylate (for example Eusolex® OCR),
3,3′-(1,4-phenylenedimethylene)bis(7,7-dimethyl-2-oxobicyclo[2.2.1]-hept-1-ylmethanesulfonic acid and salts thereof (for example Mexoryl® SX) and
2,4,6-trianilino-(p-carbo-2′-ethylhexyl-1′-oxy)-1,3,5-triazine (for example Uvinul® T 150)
hexyl 2-(4-diethylamino-2-hydroxybenzoyl)benzoate (for example Uvinul® UVA Plus, BASF).

The compounds mentioned in the list should only be regarded as examples. It is of course also possible to use other UV filters.

These organic UV filters are generally incorporated into cosmetic formulations in an amount of 0.5 to 10 percent by weight, preferably 1-8%.

Further suitable organic UV filters also are, for example,
2-(2H-benzotriazol-2-yl)-4-methyl-6-(2-methyl-3-(1,3,3,3-tetramethyl-1-(trimethylsilyloxy)disiloxanyl)propyl)phenol (for example Silatrizole®),
2-ethylhexyl 4,4′-[(6-[4-((1,1-dimethylethyl)aminocarbonyl)phenylamino]-1,3,5-triazine-2,4-diyl)diimino]bis(benzoate) (for example Uvasorb® HEB),
α-(trimethylsilyl)-ω-[trimethylsilyloxy]poly[oxy(dimethyl)silylene] [and about 6% of methyl [2-[p-[2,2-bis(ethoxycarbonyl)vinyl]phenoxy]-1-methyleneethyl] and about 1.5% of methyl[3-[p-[2,2-bis(ethoxycarbonyl)vinyl)phenoxy)propenyl) and 0.1 to 0.4% of (methylhydrogen)silylene]] (n=60) (CAS No. 207 574-74-1)
2,2′-methylenebis(6-(2H-benzotriazol-2-yl)-4-(1,1,3,3-tetramethylbutyl)phenol) (CAS No. 103 597-45-1)
2,2′-(1,4-phenylene)bis(1H-benzimidazole-4,6-disulfonic acid, monosodium salt) (CAS No. 180 898-37-7) and
2,4-bis{[4-(2-ethylhexyloxy)-2-hydroxy[phenyl}-6-(4-methoxyphenyl)-1,3,5-triazine (CAS No. 103 597-45-, 187 393-00-6).

Further suitable UV filters are methoxyflavones corresponding to the earlier German patent application DE 10232595.2.

Organic UV filters are generally incorporated into cosmetic formulations in an amount of 0.5 to 20 percent by weight, preferably 1-15%.

In order to ensure optimised UV protection, it is furthermore preferred for compositions having light-protection properties also to comprise inorganic UV filters. Conceivable inorganic UV filters are those from the group of the titanium dioxides, such as, for example, coated titanium dioxide (for example Eusolex® T-2000, Eusolex® T-AQUA), zinc oxides (for example Sachtotec®), iron oxides or also cerium oxides. These inorganic UV filters are generally incorporated into cosmetic compositions in an amount of 0.5 to 20 percent by weight, preferably 2-10%.

Preferred compounds having UV-filtering properties are 3-(4′-methylbenzylidene)-dl-camphor, 1-(4-tert-butylphenyl)-3-(4-methoxyphenyl)propane-1,3-dione, 4-isopropyldibenzoylmethane, 2-hydroxy-4-methoxybenzophenone, octyl methoxycinnamate, 3,3,5-trimethylcyclohexyl salicylate, 2-ethylhexyl 4-(dimethylamino)benzoate, 2-ethylhexyl 2-cyano-3,3-diphenylacrylate, 2-phenylbenzimidazole-5-sulfonic acid and the potassium, sodium and triethanolamine salts thereof.

Optimised compositions may comprise, for example, the combination of the organic UV filters 4′-methoxy-6-hydroxyflavone with 1-(4-tert-butylphenyl)-3-(4-methoxyphenyl)propane-1,3-dione and 3-(4′-methylbenzylidene)-dl-camphor. This combination gives rise to broad-band protection, which can also be supplemented by the addition of inorganic UV filters, such as titanium dioxide microparticles.

All the said UV filters can also be employed in encapsulated form. In particular, it is advantageous to employ organic UV filters in encapsulated form. In detail, the following advantages arise:
The hydrophilicity of the capsule wall can be set independently of the solubility of the UV filter. Thus, for example, it is also possible to incorporate hydrophobic UV filters into purely aqueous compositions. In addition, the oily impression on application of the composition comprising hydrophobic UV filters, which is frequently regarded as unpleasant, is suppressed.
Certain UV filters, in particular dibenzoylmethane derivatives, exhibit only reduced photostability in cosmetic compositions. Encapsulation of these filters or compounds which impair the photostability of these filters, such as, for example, cinnamic acid derivatives, enables the photostability of the entire composition to be increased.
Skin penetration by organic UV filters and the associated potential for irritation on direct application to the human skin are repeatedly discussed in the literature. The encapsulation of the corresponding substances which is proposed here suppresses this effect.
In general, encapsulation of individual UV filters or other ingredients enables preparation problems caused by the interaction of individual composition constituents with one another, such as crystallisation processes, precipitation and agglomerate formation, to be avoided since the interaction is suppressed.

It is therefore preferred in accordance with the invention for one or more of the above-mentioned UV filters to be in encapsulated form. It is advantageous here for the capsules to be so small that they cannot be viewed with the naked eye. In order to achieve the above-mentioned effects, it is furthermore necessary for the capsules to be sufficiently stable and the encapsulated active ingredient (UV filter) only to be released to the environment to a small extent, or not at all.

Suitable capsules can have walls of inorganic or organic polymers. For example, U.S. Pat. No. 6,242,099 B1 describes the production of suitable capsules with walls of chitin, chitin derivatives or polyhydroxylated polyamines. Capsules which can particularly preferably be employed in accordance with the invention have walls which can be obtained by a sol-gel process, as described in the applications WO 00/09652, WO 00/72806 and WO 00/71084. Preference is again given here to capsules whose walls are built up from silica gel (silica; undefined silicon oxide hydroxide). The production of corresponding capsules is known to the person skilled in the art, for example from the cited patent applications, whose contents expressly also belong to the subject-matter of the present application.

The capsules in compositions according to the invention are preferably present in amounts which ensure that the encapsulated UV filters are present in the composition in the above-indicated amounts.

Compositions which are particularly preferred in accordance with the invention also comprise one or more antioxidants.

There are many proven substances known from the specialist literature which can be used as antioxidants, for example amino acids (for example glycine, histidine, tyrosine, tryptophan) and derivatives thereof, imidazoles, (for example urocanic acid) and derivatives thereof, peptides, such as D,L-carnosine, D-carnosine, L-carnosine and derivatives thereof (for example anserine), carotinoids, carotenes (for example α-carotene, β-carotene, lycopene) and derivatives thereof, chlorogenic acid and derivatives thereof, lipoic acid and derivatives thereof (for example dihydrolipoic acid), aurothioglucose, propylthiouracil and other thiols (for example thioredoxin, glutathione, cysteine, cystine, cystamine and the glycosyl, N-acetyl, methyl, ethyl, propyl, amyl, butyl and lauryl, palmitoyl, oleyl, γ-linoleyl, cholesteryl and glyceryl esters thereof) and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (for example buthionine sulfoximines, homocysteine sulfoximine, buthionine sulfones, penta-, hexa- and heptathionine sulfoximine) in very low tolerated doses (for example pmol to pmol/kg), and also (metal) chelating agents, (for example α-hydroxy fatty acids, palmitic acid, phytic acid, lactoferrin), α-hydroxy acids (for example citric acid, lactic acid, malic acid), humic acid, bile acid, bile extracts, bilirubin, biliverdin, EDTA, EGTA and derivatives thereof, unsaturated fatty acids and derivatives thereof, vitamin C and derivatives (for example ascorbyl palmitate, magnesium ascorbyl phosphate, ascorbyl acetate), tocopherols and derivatives (for example vitamin E acetate), vitamin A and derivatives (for example vitamin A palmitate), and coniferyl benzoate of benzoin resin, rutinic acid and derivatives thereof, α-glycosyl rutin, ferulic acid, furfurylideneglucitol, carnosine, butylhydroxytoluene, butylhydroxyanisole, nordihydroguaiaretic acid, trihydroxybutyrophenone, quercetin, uric acid and derivatives thereof, mannose and derivatives thereof, zinc and derivatives thereof (for example ZnO, ZnSO₄), selenium and derivatives thereof (for example selenomethionine), stilbenes and derivatives thereof (for example stilbene oxide, trans-stilbene oxide).

Suitable antioxidants are also compounds of the general formula

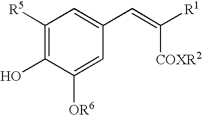

in which
R¹ can be selected from the group —C(O)CH₃, —CO₂R³, —C(O)NH₂ and —C(O)N(R⁴)₂,
X denotes O or NH,
R² denotes linear or branched alkyl having 1 to 30 C atoms,
R³ denotes linear or branched alkyl having 1 to 20 C atoms,
R⁴ in each case, independently of one another, denotes H or linear or branched alkyl having 1 to 8 C atoms,
R⁵ denotes linear or branched alkyl having 1 to 8 C atoms or linear or branched alkoxy having 1 to 8 C atoms, and
R⁶ denotes linear or branched alkyl having 1 to 8 C atoms, preferably derivatives of 2-(4-hydroxy-3,5-dimethoxybenzylidene)malonic acid, particularly preferably bis(2-ethylhexyl) 2-(4-hydroxy-3,5-dimethoxybenzylidene)malonate (for example Oxynex® ST Liquid).

Mixtures of antioxidants are likewise suitable for use in the cosmetic compositions according to the invention. Known and commercial mixtures are, for example, mixtures comprising, as active ingredients, lecithin, L-(+)-ascorbyl palmitate and citric acid (for example (for example Oxynex® AP), natural tocopherols, L-(+)-ascorbyl palmitate, L-(+)-ascorbic acid and citric acid (for example Oxynex® K LIQUID), tocopherol extracts from natural sources, L-(+)-ascorbyl palmitate, L-(+)-ascorbic acid and citric acid (for example Oxynex® L LIQUID), DL-α-tocopherol, L-(+)-ascorbyl palmitate, citric acid and lecithin (for example Oxynex® LM) or butylhydroxytoluene (BHT), L-(+)-ascorbyl palmitate and citric acid (for example Oxynex® 2004).

The compositions according to the invention may comprise vitamins as further ingredients. The cosmetic compositions according to the invention preferably comprise vitamins and vitamin derivatives selected from vitamin A, vitamin A propionate, vitamin A palmitate, vitamin A acetate, retinol, vitamin B, thiamine chloride hydrochloride (vitamin B₁), riboflavin (vitamin B₂), nicotinamide, vitamin C (ascorbic acid), vitamin D, ergocalciferol (vitamin D₂), vitamin E, DL-α-tocopherol, tocopherol E acetate, tocopherol hydrogensuccinate, vitamin K₁, esculin (vitamin P active ingredient), thiamine (vitamin B₁), nicotinic acid (niacin), pyridoxine, pyridoxal, pyridoxamine, (vitamin B₆), pantothenic acid, biotin, folic acid and cobalamine (vitamin B₁₂), particularly preferably vitamin A palmitate, vitamin C and derivatives thereof, DL-α-tocopherol, tocopherol E acetate, nicotinic acid, pantothenic acid and biotin.

Of the phenols having an antioxidative action, the polyphenols, some of which are naturally occurring, are of particular interest for applications in the pharmaceutical, cosmetic or nutrition sector. For example, the flavonoids or bioflavonoids, which are principally known as plant dyes, frequently have an antioxidant potential. K. Lemanska, H. Szymusiak, B. Tyrakowska, R. Zielinski, I. M. C. M. Rietjens; Current Topics in Biophysics 2000, 24(2), 101-108, are concerned with effects of the substitution pattern of mono- and dihydroxyflavones. It is observed therein that dihydroxyflavones containing an OH group adjacent to the keto function or OH groups in the 3′,4′- or 6,7- or 7,8-position have antioxidative properties, while other mono- and dihydroxyflavones in some cases do not have antioxidative properties.

Quercetin (cyanidanol, cyanidenolon 1522, meletin, sophoretin, ericin, 3,3′,4′,5,7-pentahydroxyflavone) is frequently mentioned as a particularly effective antioxidant (for example C. A. Rice-Evans, N. J. Miller, G. Paganga, Trends in Plant Science 1997, 2(4), 152-159). K. Lemanska, H. Szymusiak, B. Tyrakowska, R. Zielinski, A. E. M. F. Soffers, I. M. C. M. Rietjens; Free Radical Biology & Medicine 2001, 31(7), 869-881, are investigating the pH dependence of the antioxidant action of hydroxyflavones. Quercetin exhibits the greatest activity amongst the structures investigated over the entire pH range.

Suitable antioxidants are furthermore compounds of the formula V

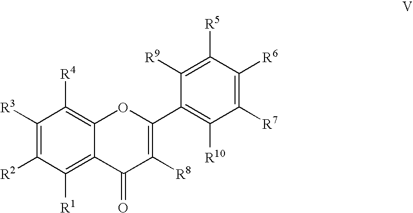

where R¹ to R¹⁰ may be identical or different and are selected from
   H
   OR
   straight-chain or branched C₁- to C₂₀-alkyl groups,
   straight-chain or branched C₃- to C₂₀-alkenyl groups,
   straight-chain or branched C₁- to C₂₀-hydroxyalkyl groups, where the hydroxyl group may be bonded to a primary or secondary carbon atom of the chain and furthermore the alkyl chain may also be interrupted by oxygen, and/or
   C₃- to C₁₀-cycloalkyl groups and/or C₃- to C₁₂-cycloalkenyl groups, where the rings may in each case also be bridged by —(CH₂)ₙ— groups, where n=1 to 3,
   where all OR¹¹, independently of one another, stand for
      OH
      straight-chain or branched C₁- to C₂₀-alkoxy groups,
      straight-chain or branched C₃- to C₂₀-alkenyloxy groups,
      straight-chain or branched C₁- to C₂₀-hydroxyalkoxy groups, where the hydroxyl group(s) may be bonded to a primary or secondary carbon atom of the chain and furthermore the alkyl chain may also be interrupted by oxygen, and/or
      C₃- to C₁₀-cycloalkoxy groups and/or C₃- to C₁₂-cycloalkenyloxy groups, where the rings may in each case also be bridged by —(CH₂)ₙ— groups, where n=1 to 3, and/or
      mono- and/or oligoglycosyl radicals,
   with the proviso that at least 4 radicals from R¹ to R⁷ stand for OH and that at least 2 pairs of adjacent —OH groups are present in the molecule,
   or R², R⁵ and R⁶ stand for OH and the radicals R¹, R³, R⁴ and R⁷⁻¹⁰ stand for H,
      as described in the earlier German patent application DE 10244282.7.

Advantages of the compositions according to the invention comprising at least one antioxidant, besides the above-mentioned advantages, are, in particular, the antioxidant action and the good tolerance by the skin. In addition, preferred compounds of those described here are colourless or only weakly coloured and thus do not result in discoloration of the compositions, or only do so to a small extent. Particularly advantageous is the particular action profile of the compounds of the formula V, which is evident in the DPPH assay from a high capacity for scavenging free radicals (EC₅₀), a delayed action (T_{EC50}>120 min) and thus morate to high anti-free-radical efficiency (AE). In addition, the compounds of the formula V combine in the molecule antioxidative properties with UV absorption in the UV-A and/or -B region. Preference is therefore also given to compositions comprising at least one compound of the formula V which is characterised in that at least two adjacent radicals of the radicals R¹ to R⁴ stand for OH and at least two adjacent radicals of the radicals R⁵ to R⁷ stand for OH. Particularly preferred compositions comprise at least one compound of the formula V which is characterised in that at least three adjacent radicals of the radicals R¹ to R⁴ stand for OH, where the radicals R¹ to R³ preferably stand for OH.

The compositions according to the invention may in addition comprise further conventional skin-protecting or skin-care active ingredients. These may in principle be all active ingredients known to the person skilled in the art.

Particularly preferred active ingredients are, for example, also so-called compatible solutes. These are substances which are involved in the osmo-regulation of plants or microorganisms and can be isolated from these organisms. The generic term compatible solutes here also encompasses the osmolytes described in German patent application DE-A-10133202. Suitable osmolytes are, for example, the polyols, methylamine compounds and amino acids and the respective precursors thereof. For the purposes of German patent application DE-A-10133202, osmolytes are taken to mean, in particular, substances from the group of the polyols, such as, for example, myo-inositol, mannitol or sorbitol and/or one or more of the osmolytically active substances mentioned below:

taurine, choline, betaine, phosphorylcholine, glycerophosphorylcholines, glutamine, glycine, α-alanine, glutamate, aspartate, proline, and taurine. Precursors of these substances are, for example, glucose, glucose polymers, phosphatidylcholine, phosphatidylinositol, inorganic phosphates, proteins, peptides and polyamino acids. Precursors are, for example, compounds which are converted into osmolytes by metabolic steps.

In accordance with the invention, compatible solutes are preferably sub-stances selected from the group consisting of pyrimidinecarboxylic acids (such as ectoin and hydroxyectoin), proline, betaine, glutamine, cyclic diphosphoglycerate, N-acetylornithine, trimethylamine N-oxide, di-myo-inositol phosphate (DIP), cyclic 2,3-diphosphoglycerate (cDPG), 1,1-diglycerol phosphate (DGP), β-mannosyl glycerate (firoin), β-mannosylglyceramide (firoin A) or/und dimannosyl diinositol phosphate (DMIP) or an optical isomer, derivative, for example an acid, or a salt or ester of these compounds, or combinations thereof.

Of the pyrimidinecarboxylic acids, particular mention should be made here of ectoin ((S)-1,4,5,6-tetrahydro-2-methyl-4-pyrimidinecarboxylic acid) and hydroxyectoin ((S,S)-1,4,5,6-tetrahydro-5-hydroxy-2-methyl-4-pyrim idi necarboxylic acid) and derivatives thereof. These compounds stabilise enzymes and other biomolecules in aqueous solutions and organic solvents. Furthermore, they stabilise, in particular, enzymes against denaturing conditions, such as salts, extreme pH values, surfactants, urea, guanidinium chloride and other compounds.

Ectoin and ectoin derivatives, such as hydroxyectoin, can advantageously be used in medicaments. In particular, hydroxyectoin can be employed for the preparation of a medicament for the treatment of skin diseases. Other areas of application of hydroxyectoin and other ectoin derivatives are typically in areas in which, for example, trehalose is used as additive. Thus, ectoin derivatives, such as hydroxyectoin, can be used as protectant in dried yeast and bacteria cells. Pharmaceutical products, such as non-glycosylated, pharmaceutical active peptides and proteins, for example t-PA, can also be protected with ectoin or its derivatives.

Of the cosmetic applications, particular mention should be made of the use of ectoin and ectoin derivatives for the care of aged, dry or irritated skin. Thus, European patent application EP-A-0 671 161 describes, in particular, that ectoin and hydroxyectoin are employed in cosmetic compositions, such as powders, soaps, surfactant-containing cleansing products, lipsticks, rouge, make-up, care creams and sunscreen preparations.

Preference is given here to the use of a pyrimidinecarboxylic acid of the following formula VI

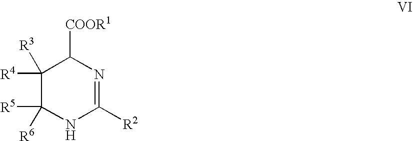

in which R¹ is a radical H or C1-8-alkyl, R² is a radical H or C1-4-alkyl, and R³, R⁴, R⁵ and R⁶ are each, independently of one another, a radical from the group H, OH, NH₂ and C1-4-alkyl. Preference is given to the use of pyrimidinecarboxylic acids in which R² is a methyl or ethyl group, and R¹ or R⁵ and R⁶ are H. Particular preference is given to the use of the pyrimidinecarboxylic acids ectoin ((S)-1,4,5,6-tetrahydro-2-methyl-4-pyrimidinecarboxylic acid) and hydroxyectoin ((S,S)-1,4,5,6-tetrahydro-5-hydroxy-2-methyl-4-pyrimidinecarboxylic acid). The compositions according to the invention preferably comprise pyrimidinecarboxylic acids of this type in amounts of up to 15% by weight.

It is particularly preferred in accordance with the invention for the compatible solutes to be selected from di-myo-inositol phosphate (DIP), cyclic 2,3-diphosphoglycerate (cDPG), 1,1-diglycerol phosphate (DGP), β-mannosyl glycerate (firoin), β-mannosylglyceramide (firoin-A) or/and di-mannosyl diinositol phosphate (DMIP), ectoin, hydroxyectoin or mixtures thereof.

All compounds or components which can be used in the compositions are either known and commercially available or can be synthesised by known processes and can be incorporated into cosmetic or dermatological compositions in the customary manner. Suitable compositions are those for external use, for example in the form of a cream, lotion, gel, or as a solution which can be sprayed onto the skin. Suitable for internal use are administration forms such as capsules, coated tablets, powders, tablet solutions or solutions.

Examples which may be mentioned of application forms of the compositions according to the invention are: solutions, suspensions, emulsions, PIT emulsions, pastes, ointments, gels, creams, lotions, powders, soaps, surfactant-containing cleansing preparations, oils, aerosols and sprays. Examples of other application forms are sticks, shampoos and shower products. Any desired customary vehicles, assistants and, if desired, further active ingredients may be added to the composition.

Preferred assistants originate from the group of the preservatives, antioxidants, stabilisers, solubilisers, vitamins, colorants, odour enhancers.

Ointments, pastes, creams and gels may comprise the customary vehicles, for example animal and vegetable fats, waxes, paraffins, starch, tragacanth, cellulose derivatives, polyethylene glycols, silicones, bentonites, silica, talc and zinc oxide, or mixtures of these substances.

Powders and sprays may comprise the customary vehicles, for example lactose, talc, silica, aluminium hydroxide, calcium silicate and polyamide powder, or mixtures of these substances. Sprays may additionally comprise the customary propellants, for example chlorofluorocarbons, propane/butane or dimethyl ether.

Solutions and emulsions may comprise the customary vehicles, such as solvents, solubilisers and emulsifiers, for example water, ethanol, isopropanol, ethyl carbonate, ethyl acetate, benzyl alcohol, benzyl benzoate, propylene glycol, 1,3-butyl glycol, oils, in particular cottonseed oil, peanut oil, wheatgerm oil, olive oil, castor oil and sesame oil, glycerol fatty acid esters, polyethylene glycols and fatty acid esters of sorbitan, or mixtures of these substances.

Suspensions may comprise the customary vehicles, such as liquid diluents, for example water, ethanol or propylene glycol, suspending agents, for example ethoxylated isostearyl alcohols, polyoxyethylene sorbitol esters and polyoxyethylene sorbitan esters, microcrystalline cellulose, aluminium metahydroxide, bentonite, agar-agar and tragacanth, or mixtures of these substances.

Soaps may comprise the customary vehicles, such as alkali metal salts of fatty acids, salts of fatty acid monoesters, fatty acid protein hydrolysates, isethionates, lanolin, fatty alcohol, vegetable oils, plant extracts, glycerol, sugars, or mixtures of these substances.

Surfactant-containing cleansing products may comprise the customary vehicles, such as salts of fatty alcohol sulfates, fatty alcohol ether sulfates, sulfosuccinic acid monoesters, fatty acid protein hydrolysates, isethionates, imidazolinium derivatives, methyl taurates, sarcosinates, fatty acid amide ether sulfates, alkylamidobetaines, fatty alcohols, fatty acid glycerides, fatty acid diethanolamides, vegetable and synthetic oils, lanolin derivatives, ethoxylated glycerol fatty acid esters, or mixtures of these substances.

Face and body oils may comprise the customary vehicles, such as synthetic oils, such as fatty acid esters, fatty alcohols, silicone oils, natural oils, such as vegetable oils and oily plant extracts, paraffin oils, lanolin oils, or mixtures of these substances.

Further typical cosmetic application forms are also lipsticks, lip-care sticks, mascara, eyeliner, eyeshadow, rouge, powder make-up, emulsion make-up and wax make-up, and sunscreen, pre-sun and after-sun preparations.

The preferred composition forms according to the invention include, in particular, emulsions.

Emulsions according to the invention are advantageous and comprise, for example, the said fats, oils, waxes and other fatty substances, as well as water and an emulsifier, as usually used for a composition of this type.

The lipid phase may advantageously be selected from the following group of substances:
mineral oils, mineral waxes;
oils, such as triglycerides of capric or caprylic acid, furthermore natural oils, such as, for example, castor oil;
fats, waxes and other natural and synthetic fatty substances, preferably esters of fatty acids with alcohols having a low carbon number, for example with isopropanol, propylene glycol or glycerol, or esters of fatty alcohols with alkanoic acids having a low carbon number or with fatty acids;
silicone oils, such as dimethylpolysiloxanes, diethylpolysiloxanes, diphenylpolysiloxanes and mixed forms thereof.

For the purposes of the present invention, the oil phase of the emulsions, oleogels or hydrodispersions or lipodispersions is advantageously selected from the group of the esters of saturated and/or unsaturated, branched and/or unbranched alkanecarboxylic acids having a chain length of 3 to 30 C atoms and saturated and/or unsaturated, branched and/or unbranched alcohols having a chain length of 3 to 30 C atoms, from the group of the esters of aromatic carboxylic acids and saturated and/or unsaturated, branched and/or unbranched alcohols having a chain length of 3 to 30 C atoms. Ester oils of this type can then advantageously be selected from the group isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethylhexyl laurate, 2-hexyldecyl stearate, 2-octyldodecyl palmitate, oleyl oleate, oleyl erucate, erucyl oleate, erucyl erucate and synthetic, semisynthetic and natural mixtures of esters of this type, for example jojoba oil.

The oil phase may furthermore advantageously be selected from the group of the branched and unbranched hydrocarbons and waxes, silicone oils, dialkyl ethers, the group of the saturated or unsaturated, branched or unbranched alcohols, and fatty acid triglycerides, specifically the triglycerol esters of saturated and/or unsaturated, branched and/or unbranched alkanecarboxylic acids having a chain length of 8 to 24 C atoms, in particular 12-18 C atoms. The fatty acid triglycerides may advantageously be selected, for example, from the group of the synthetic, semi-synthetic and natural oils, for example olive oil, sunflower oil, soya oil, peanut oil, rapeseed oil, almond oil, palm oil, coconut oil, palm kernel oil and the like.

Any desired mixtures of oil and wax components of this type may also advantageously be employed for the purposes of the present invention. It may also be advantageous to employ waxes, for example cetyl palmitate, as the only lipid component of the oil phase.

The oil phase is advantageously selected from the group 2-ethylhexyl isostearate, octyldodecanol, isotridecyl isononanoate, isoeicosane, 2-ethylhexyl cocoate, C₁₂₋₁₅-alkyl benzoate, caprylic/capric acid triglyceride, dicapryl ether.

Particularly advantageous are mixtures of C₁₂₋₁₅-alkyl benzoate and 2-ethylhexyl isostearate, mixtures of C₁₂₋₁₅-alkyl benzoate and isotridecyl isononanoate, as well as mixtures of C₁₂₋₁₅-alkyl benzoate, 2-ethylhexyl isostearate and isotridecyl isononanoate.

Of the hydrocarbons, paraffin oil, squalane and squalene may advantageously be used for the purposes of the present invention.

Furthermore, the oil phase may also advantageously have a content of cyclic or linear silicone oils or consist entirely of oils of this type, although it is preferred to use an additional content of other oil-phase components in addition to the silicone oil or the silicone oils.

The silicone oil to be used in accordance with the invention is advantageously cyclomethicone (octamethylcyclotetrasiloxane). However, it is also advantageous for the purposes of the present invention to use other silicone oils, for example hexamethylcyclotrisiloxane, polydimethylsiloxane, poly(methylphenylsiloxane).

Also particularly advantageous are mixtures of cyclomethicone and isotridecyl isononanoate and of cyclomethicone and 2-ethylhexyl isostearate.

The aqueous phase of the compositions according to the invention optionally advantageously comprises alcohols, diols or polyols having a low carbon number, and ethers thereof, preferably ethanol, isopropanol, propylene glycol, glycerol, ethylene glycol, ethylene glycol monoethyl or monobutyl ether, propylene glycol monomethyl, monoethyl or monobutyl ether, diethylene glycol monomethyl or monoethyl ether and analogous products, furthermore alcohols having a low carbon number, for example ethanol, isopropanol, 1,2-propanediol, glycerol, and, in particular, one or more thickeners, which may advantageously be selected from the group silicon dioxide, aluminium silicates, polysaccharides and derivatives thereof, for example hyaluronic acid, xanthan gum, hydroxypropylmethylcellulose, particularly advantageously from the group of the polyacrylates, preferably a polyacrylate from the group of the so-called Carbopols, for example Carbopol grades 980, 981, 1382, 2984, 5984, in each case individually or in combination.

In particular, a mixture of the above-mentioned solvents is used. In the case of alcoholic solvents, water may be a further constituent.

Emulsions according to the invention are advantageous and comprise, for example, the said fats, oils, waxes and other fatty substances, as well as water and an emulsifier, as usually used for a formulation of this type.

In a preferred embodiment, the compositions according to the invention comprise hydrophilic surfactants.

The hydrophilic surfactants are preferably selected from the group of the alkylglucosides, acyl lactylates, betaines and coconut amphoacetates.

The alkylglucosides are themselves advantageously selected from the group of the alkylglucosides which are distinguished by the structural formula

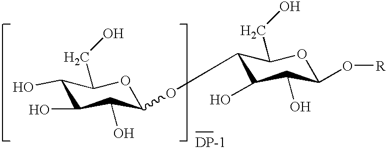

where R represents a branched or unbranched alkyl radical having 4 to 24 carbon atoms, and where D̅P̅ denotes a mean degree of glucosylation of up to 2.

The value D̅P̅ represents the degree of glucosidation of the alkylglucosides used in accordance with the invention and is defined as

$$\overline{DP} = \frac{{p}_{1}}{100} \cdot 1 + \frac{{p}_{2}}{100} \cdot 2 + \frac{{p}_{3}}{100} \cdot 3 + … = \sum \frac{{p}_{i}}{100} \cdot i$$

in which p₁, p₂, p₃ . . . pᵢ represent the proportion of mono-, di-, tri- . . . i-fold glucosylated products in percent by weight. Products having degrees of glucosylation of 1-2, particularly advantageously of 1.1 to 1.5, very particularly advantageously of 1.2-1.4, in particular of 1.3, are advantageously selected in accordance with the invention.

The value DP takes into account the fact that alkylglucosides generally, as a consequence of their preparation, represent mixtures of mono- and oligoglucosides. A relatively high content of monoglucosides, typically in the order of 40-70% by weight, is advantageous in accordance with the invention.

Alkylglucosides which are particularly advantageously used in accordance with the invention are selected from the group octyl glucopyranoside, nonyl glucopyranoside, decyl glucopyranoside, undecyl glucopyranoside, dodecyl glucopyranoside, tetradecyl glucopyranoside and hexadecyl glucopyranoside.

It is likewise advantageous to employ natural or synthetic raw materials and assistants or mixtures which are distinguished by an effective content of the active ingredients used in accordance with the invention, for example Plantaren® 1200 (Henkel KGaA), Oramix® NS 10 (Seppic).

The acyllactylates are themselves advantageously selected from the group of the substances which are distinguished by the structural formula

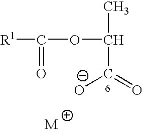

where R¹ denotes a branched or unbranched alkyl radical having 1 to 30 carbon atoms, and M⁺ is selected from the group of the alkali metal ions and the group of the ammonium ions which are substituted by one or more alkyl and/or one or more hydroxyalkyl radicals, or corresponds to half an equivalent of an alkaline earth metal ion.

For example, sodium isostearyl lactylate, for example the product Pathionic® ISL from the American Ingredients Company, is advantageous.

The betaines are advantageously selected from the group of the sub-stances which are distinguished by the structural formula

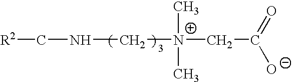

where R² denotes a branched or unbranched alkyl radical having 1 to 30 carbon atoms.

R² particularly advantageously denotes a branched or unbranched alkyl radical having 6 to 12 carbon atoms.

For example, capramidopropylbetaine, for example the product Tego, Betain 810 from Th. Goldschmidt AG, is advantageous.

A coconut amphoacetate which is advantageous in accordance with the invention is, for example, sodium coconut amphoacetate, as available under the name Miranol® Ultra C32 from Miranol Chemical Corp.

The compositions according to the invention are advantageously characterised in that the hydrophilic surfactant(s) is (are) present in concentrations of 0.01-20% by weight, preferably 0.05-10% by weight, particularly preferably 0.1-5% by weight, in each case based on the total weight of the composition.

For use, the cosmetic and dermatological compositions according to the invention are applied to the skin and/or the hair in an adequate amount in the usual manner for cosmetics.

Cosmetic and dermatological compositions according to the invention may exist in various forms. Thus, they may be, for example, a solution, a water-free composition, an emulsion or microemulsion of the water-in-oil (W/O) type or of the oil-in-water (O/W) type, a multiple emulsion, for example of the water-in-oil-in-water (W/O/W) type, a gel, a solid stick, an ointment or an aerosol. It is also advantageous to administer ectoins in encapsulated form, for example in collagen matrices and other conventional encapsulation materials, for example as cellulose encapsulations, in gelatine, wax matrices or liposomally encapsulated. In particular, wax matrices, as described in DE-A 43 08 282, have proven favourable. Preference is given to emulsions. O/W emulsions are particularly preferred. Emulsions, W/O emulsions and O/W emulsions are obtainable in a conventional manner.

Emulsifiers that can be used are, for example, the known W/O and O/W emulsifiers. It is advantageous to use further conventional co-emulsifiers in the preferred O/W emulsions according to the invention.

Co-emulsifiers which are advantageous in accordance with the invention are, for example, O/W emulsifiers, principally from the group of the sub-stances having HLB values of 11-16, very particularly advantageously having HLB values of 14.5-15.5, so long as the O/W emulsifiers have saturated radicals R and R′. If the O/W emulsifiers have unsaturated radicals R and/or R′ or in the case of isoalkyl derivatives, the preferred HLB value of such emulsifiers may also be lower or higher.

It is advantageous to select the fatty alcohol ethoxylates from the group of the ethoxylated stearyl alcohols, cetyl alcohols, cetylstearyl alcohols (cetearyl alcohols). Particular preference is given to the following: polyethylene glycol (13) stearyl ether (steareth-13), polyethylene glycol (14) stearyl ether (steareth-14), polyethylene glycol (15) stearyl ether (steareth-15), polyethylene glycol (16) stearyl ether (steareth-16), polyethylene glycol (17) stearyl ether (steareth-17), polyethylene glycol (18) stearyl ether (steareth-18), polyethylene glycol (19) stearyl ether (steareth-19), polyethylene glycol (20) stearyl ether (steareth-20), polyethylene glycol (12) isostearyl ether (isosteareth-12), polyethylene glycol (13) isostearyl ether (isosteareth-13), polyethylene glycol (14) isostearyl ether (isosteareth-14), polyethylene glycol (15) isostearyl ether (isosteareth-15), polyethylene glycol (16) isostearyl ether (isosteareth-16), polyethylene glycol (17) isostearyl ether (isosteareth-17), polyethylene glycol (18) isostearyl ether (isosteareth-18), polyethylene glycol (19) isostearyl ether (isosteareth-19), polyethylene glycol (20) isostearyl ether (isosteareth-20), polyethylene glycol (13) cetyl ether (ceteth-13), polyethylene glycol (14) cetyl ether (ceteth-14), polyethylene glycol (15) cetyl ether (ceteth-15), polyethylene glycol (16) cetyl ether (ceteth-16), polyethylene glycol (17) cetyl ether (ceteth-17), polyethylene glycol (18) cetyl ether (ceteth-18), polyethylene glycol (19) cetyl ether (ceteth-19), polyethylene glycol (20) cetyl ether (ceteth-20), polyethylene glycol (13) isocetyl ether (isoceteth-13), polyethylene glycol (14) isocetyl ether (isoceteth-14), polyethylene glycol (15) isocetyl ether (isoceteth-15), polyethylene glycol (16) isocetyl ether (isoceteth-16), polyethylene glycol (17) isocetyl ether (isoceteth-17), polyethylene glycol (18) isocetyl ether (isoceteth-18), polyethylene glycol (19) isocetyl ether (isoceteth-19), polyethylene glycol (20) isocetyl ether (isoceteth-20), polyethylene glycol (12) oleyl ether (oleth-12), polyethylene glycol (13) oleyl ether (oleth-13), polyethylene glycol (14) oleyl ether (oleth-14), polyethylene glycol (15) oleyl ether (oleth-15), polyethylene glycol (12) lauryl ether (laureth-12), polyethylene glycol (12) isolauryl ether (isolaureth-12), polyethylene glycol (13) cetylstearyl ether (ceteareth-13), polyethylene glycol (14) cetylstearyl ether (ceteareth-14), polyethylene glycol (15) cetylstearyl ether (ceteareth-15), polyethylene glycol (16) cetylstearyl ether (ceteareth-16), polyethylene glycol (17) cetylstearyl ether (ceteareth-17), polyethylene glycol (18) cetylstearyl ether (ceteareth-18), polyethylene glycol (19) cetylstearyl ether (ceteareth-19), polyethylene glycol (20) cetylstearyl ether (ceteareth-20).

It is furthermore advantageous to select the fatty acid ethoxylates from the following group:

polyethylene glycol (20) stearate, polyethylene glycol (21) stearate, polyethylene glycol (22) stearate, polyethylene glycol (23) stearate, polyethylene glycol (24) stearate, polyethylene glycol (25) stearate, polyethylene glycol (12) isostearate, polyethylene glycol (13) isostearate, polyethylene glycol (14) isostearate, polyethylene glycol (15) isostearate, polyethylene glycol (16) isostearate, polyethylene glycol (17) isostearate, polyethylene glycol (18) isostearate, polyethylene glycol (19) isostearate, polyethylene glycol (20) isostearate, polyethylene glycol (21) isostearate, polyethylene glycol (22) isostearate, polyethylene glycol (23) isostearate, polyethylene glycol (24) isostearate, polyethylene glycol (25) isostearate, polyethylene glycol (12) oleate, polyethylene glycol (13) oleate, polyethylene glycol (14) oleate, polyethylene glycol (15) oleate, polyethylene glycol (16) oleate, polyethylene glycol (17) oleate, polyethylene glycol (18) oleate, polyethylene glycol (19) oleate, polyethylene glycol (20) oleate.

An ethoxylated alkyl ether carboxylic acid or salt thereof which can advantageously be used is sodium laureth-11 carboxylate. An alkyl ether sulfate which can advantageously be used is sodium laureth-14 sulfate. An ethoxylated cholesterol derivative which can advantageously be used is polyethylene glycol (30) cholesteryl ether. Polyethylene glycol (25) soyasterol has also proven successful. Ethoxylated triglycerides which can advantageously be used are the polyethylene glycol (60) evening primrose glycerides.

It is furthermore advantageous to select the polyethylene glycol glycerol fatty acid esters from the group polyethylene glycol (20) glyceryl laurate, polyethylene glycol (21) glyceryl laurate, polyethylene glycol (22) glyceryl laurate, polyethylene glycol (23) glyceryl laurate, polyethylene glycol (6) glyceryl caprate/caprinate, polyethylene glycol (20) glyceryl oleate, polyethylene glycol (20) glyceryl isostearate, polyethylene glycol (18) glyceryl oleate/cocoate.

It is likewise favourable to select the sorbitan esters from the group c polyethylene glycol (20) sorbitan monolaurate, polyethylene glycol (20) sorbitan monostearate, polyethylene glycol (20) sorbitan monoisostearate, polyethylene glycol (20) sorbitan monopalmitate, polyethylene glycol (20) sorbitan monooleate.

The following can be employed as optional W/O emulsifiers, but ones which may nevertheless be advantageous in accordance with the invention:

fatty alcohols having 8 to 30 C atoms, monoglycerol esters of saturated and/or unsaturated, branched and/or unbranched alkanecarboxylic acids having a chain length of 8 to 24 C atoms, in particular 12-18 C atoms, diglycerol esters of saturated and/or unsaturated, branched and/or unbranched alkanecarboxylic acids having a chain length of from 8 to 24 C atoms, in particular 12-18 C atoms, monoglycerol ethers of saturated and/or unsaturated, branched and/or unbranched alcohols having a chain length of 8 to 24 C atoms, in particular 12-18 C atoms, diglycerol ethers of saturated and/or unsaturated, branched and/or unbranched alcohols having a chain length of 8 to 24 C atoms, in particular 12-18 C atoms, propylene glycol esters of saturated and/or unsaturated, branched and/or unbranched alkanecarboxylic acids having a chain length of 8 to 24 C atoms, in particular 12-18 C atoms, and sorbitan esters of saturated and/or unsaturated, branched and/or unbranched alkanecarboxylic acids having a chain length of 8 to 24 C atoms, in particular 12-18 C atoms.

Particularly advantageous W/O emulsifiers are glyceryl monostearate, glyceryl monoisostearate, glyceryl monomyristate, glyceryl monooleate, diglyceryl monostearate, diglyceryl monoisostearate, propylene glycol monostearate, propylene glycol monoisostearate, propylene glycol monocaprylate, propylene glycol monolaurate, sorbitan monoisostearate, sorbitan monolaurate, sorbitan monocaprylate, sorbitan monoisooleate, sucrose distearate, cetyl alcohol, stearyl alcohol, arachidyl alcohol, behenyl alcohol, isobehenyl alcohol, selachyl alcohol, chimyl alcohol, polyethylene glycol (2) stearyl ether (steareth-2), glyceryl monolaurate, glyceryl monocaprinate, glyceryl monocaprylate or PEG 30 dipolyhydroxystearate.

Preferred compositions in accordance with the invention are suitable for repelling insects, but they are also suitable, with the corresponding additives as described above, for protecting human skin against ageing processes and against oxidative stress, i.e. against damage caused by free radicals, as are produced, for example, by solar irradiation, heat or other influences. In this connection, a composition of this type is in various administration forms usually used for this application. For example, they may, in particular, be in the form of a lotion or emulsion, such as in the form of a cream or milk (O/W, W/O, O/W/O, W/O/W), in the form of oily/alcoholic, oily/aqueous or aqueous/alcoholic gels or solutions, in the form of solid sticks or may be formulated as an aerosol.

The composition may comprise cosmetic adjuvants which are usually used in this type of composition, such as, for example, thickeners, softeners, moisturisers, surface-active agents, emulsifiers, preservatives, antifoams, perfumes, waxes, lanolin, propellants, dyes and/or pigments which colour the composition itself or the skin, and other ingredients usually used in cosmetics.

The dispersant or solubiliser used can be an oil, wax or other fatty substances, a lower monoalcohol or lower polyol or mixtures thereof. Particularly preferred monoalcohols or polyols include ethanol, i-propanol, propylene glycol, glycerol and sorbitol.

A preferred embodiment of the invention is an emulsion in the form of a protective cream or milk which comprises, for example, fatty alcohols, fatty acids, fatty acid esters, in particular triglycerides of fatty acids, lanolin, natural and synthetic oils or waxes and emulsifiers in the presence of water.

Further preferred embodiments are oily lotions based on natural or synthetic oils and waxes, lanolin, fatty acid esters, in particular triglycerides of fatty acids, or oily/alcoholic lotions based on a lower alcohol, such as ethanol, or a glycerol, such as propylene glycol, and/or a polyol, such as glycerol, and oils, waxes and fatty acid esters, such as triglycerides of fatty acids.

The composition according to the invention may also be in the form of an alcoholic gel which comprises one or more lower alcohols or polyols, such as ethanol, propylene glycol or glycerol, and a thickener, such as siliceous earth. The oily/alcoholic gels also comprise natural or synthetic oil or wax.

The solid sticks consist of natural or synthetic waxes and oils, fatty alcohols, fatty acids, fatty acid esters, lanolin and other fatty substances.

If a composition is formulated as an aerosol, the customary propellants, such as alkanes, fluoroalkanes and chlorofluoroalkanes, are generally used.

The present invention furthermore relates to a process for the preparation of a composition, characterised in that an insect repellent as action enhancer, as described above, but particularly preferably 2-(2-hydroxyethyl)-1-methylpropyl 1-piperidinecarboxylate, and at least one second insect repellent, as described above, are mixed with a cosmetically or dermatologically suitable vehicle.

The compositions according to the invention can be prepared with the aid of techniques which are well known to the person skilled in the art.

The mixing can result in dissolution, emulsification or dispersion, for example of the 2-(2-hydroxyethyl)-1-methylpropyl 1-piperidinecarboxylate and the at least second insect repellent, as described above, in the vehicle.

The following examples explain the present invention in greater detail, without restricting the scope of protection. In particular, the features, properties and advantages described in the examples, of the compounds on which the relevant examples are based can also be applied to other sub-stances and compounds not mentioned in detail, but falling within the scope of protection, so long as the contrary is not stated elsewhere. In addition, the invention can be carried out throughout the entire claimed scope and is not restricted to the examples mentioned here.

### EXAMPLES

### Example 1

### Repellent Activity

The testing is carried out by a proven test method of the Swiss Tropics Institute (“cage test”). The experimental animals used are about 300-400 female and male (about 1:1) yellow fever mosquitoes (Aedes aegypti) bred in the laboratory in a breeding cage measuring 40×40×40 cm. In order to ensure that all mosquito females are hungry during the test phase, the test population is denied sugar water on the evening before the test day. Each test begins between 8 and 10 o'clock in the morning. The exposures take place in light under constant conditions, 27° C. and 70-80% relative atmospheric humidity.

The test recipe employed is a spray of the following composition (INCI names):

| | % by weight |
|---|---|
| A | |
| Insect repellent mixture | as in table |
| PEG-8 | 5.0 |
| PPG-15 STEARYL ETHER | 3.0 |
| B | |
| ALCOHOL | 35.0 |
| METHYL PROPANEDIOL | 4.0 |
| POLYSORBATE 20 | 1.5 |
| AQUA (WATER) | to 100 |

Phases A and B are prepared separately, and phase B is subsequently stirred slowly into phase A.

500-600 cm² of the forearm of each of five test subjects are treated with the test substance between the wrist and elbow. The elbow and upper arm are covered for the exposures with a plastic sleeve which protects against bites. The untreated hand is protected by thick, air-permeable gloves and thus simultaneously serves as control for the willingness of the mosquitoes to bite.

Care is furthermore taken that the treated areas remain untouched during the test time. For the test, the forearm and hand are held in the mosquito cage hourly, and the number of biting mosquitoes a) which attempt to bite through the glove (positive control),
b) which fly closer than 3 cm to the treated area,
c) remain sitting on the treated area for longer than 2 seconds and
d) bite and suck blood in the treated area,
   is noted for 10 minutes.

Note: parameters a and b are estimated values since precise determination is not possible.

The test is terminated when the test subject finds the stress caused by the mosquito bites too unpleasant.

### Control

For the determination of the efficacy of the test products compared with an untreated test area, a study is attached which was carried out under identical external conditions. In this, a reduced number of mosquitoes, 20 Aedes aegypti females, was used in order to keep the number of bites within bearable limits. Twenty test subjects exposed a forearm until 3 bites had definitely taken place. The effective exposure time was recorded and used together with the effective number of bites for calculation of the mosquitoes biting per minute. The value obtained in this way was on average 8.44 biting mosquitoes per minute.

### Evaluation and Interpretation:

The repellent action of a substance arises in particular from the ratio of the bite-happy mosquitoes sitting on the glove to the other values. Mosquitoes buzzing around in the vicinity or even sitting are also of importance for the degree of perceived annoyance. The number of biting mosquitoes is the crucial factor for the efficacy duration to be determined and thus indirectly also for the risk of infection in the tropics.

For the approximate calculation of the protective action in percent for the products employed in the present test, the value obtained from the control for 20 mosquitoes is extrapolated to the approximately 150 mosquito females in the current test (rounded control value×7.5). The average reduction with respect to bite protection as a consequence of the action of the test products in percent for each exposure time arises from the average difference between the value found in the test and the control value.

$$\frac{control value - ( 3 {x}_{1 to n} \text{:} n )}{control value} \leq 100 ( \% )$$

xᵢ=number of events per minute=number of bites per minute
n=number of subjects still in the test
control value: bites per minute=60

This means that the protective action is better, the closer the percentage determined is to 100%.

| | Test | | | | | |
|---|---|---|---|---|---|---|
| Batch | subject | 1 h | 2 h | 3 h | 4 h | 5 h |
| 20% of IR3535 ® | 1 | 98% | | | | |
| 20% of IR3535 ® | 2 | 97% | | | | |
| 20% of IR3535 ® | 3 | 100% | 99% | 100% | 98% | |
| 20% of IR3535 ® | 4 | 100% | 100% | 97% | | |
| 20% of IR3535 ® | 5 | 98% | | | | |
| 10% of IR3535 ® | 1 | 95% | | | | |
| 10% of IR3535 ® | 2 | 100% | 90% | | | |
| 10% of IR3535 ® | 3 | 90% | | | | |
| 10% of IR3535 ® | 4 | 88% | | | | |
| 10% of IR3535 ® | 5 | 95% | | | | |
| 10% of IR3535 ® + | 1 | 65% | | | | |
| 5% of icaridin | | | | | | |
| 10% of IR3535 ® + | 2 | <92% | | | | |
| 5% of icaridin | | | | | | |
| 10% of IR3535 ® + | 3 | 91% | | | | |
| 5% of icaridin | | | | | | |
| 10% of IR3535 ® + | 4 | 92% | | | | |
| 5% of icaridin | | | | | | |
| 10% of IR3535 ® + | 5 | 99% | 99% | | | |
| 5% of icaridin | | | | | | |
| 10% of IR3535 ® + | 1 | 94% | | | | |
| 3% of icaridin | | | | | | |
| 10% of IR3535 ® + | 2 | 99% | 99% | | | |
| 3% of icaridin | | | | | | |
| 10% of IR3535 ® + | 3 | 97% | | | | |
| 3% of icaridin | | | | | | |
| 10% of IR3535 ® + | 4 | 97% | | | | |
| 3% of icaridin | | | | | | |
| 10% of IR3535 ® + | 5 | <92% | | | | |
| 3% of icaridin | | | | | | |
| 10% of IR3535 ® + | 1 | 100% | 100% | | | |
| 2% of icaridin | | | | | | |
| 10% of IR3535 ® + | 2 | 100% | 100% | | | |
| 2% of icaridin | | | | | | |
| 10% of IR3535 ® + | 3 | 100% | 99% | 100% | 99% | 99% |
| 2% of icaridin | | | | | | |
| 10% of IR3535 ® + | 4 | 77% | | 97% | | |
| 2% of icaridin | | | | | | |
| 10% of IR3535 ® + | 5 | 97% | | 100% | 97% | |
| 2% of icaridin | | | | | | |

### Determination of the Relative Repellent Action:

The protection factors found were added up over all test subjects (100%=100, 90%=90, etc.). The resultant overall factor is divided between the batches, where the experiment with 10% of IR3535® serves as standardisation basis (=100% relative repellent action).

The protection time indicated arises directly from the measurements.

| | | Relative repellent | |
|---|---|---|---|
| | | action (10% of | |
| | Repellent | IR3535 ® = 100%) | Protection |
| Formulation | factor | [%] | duration [h] |
| 20% of IR3535 ® | 987 | 177 | 3.5 |
| 10% of IR3535 ® | 558 | 100 | 2.0 |
| 10% of IR3535 ® + | 538 | 96 | 1.9 |
| 5% of icaridin | | | |
| 10% of IR3535 ® + | 578 | 104 | 2.1 |
| 3% of icaridin | | | |
| 10% of IR3535 ® + | 1268 | 227 | 4.5 |
| 2% of icaridin | | | |

In a further series of experiments by the test method indicated, the following data are obtained:

| | | Relative repellent | |
|---|---|---|---|
| | | action (15% of | |
| | Repellent | IR3535 ® = 100%) | Protection |
| Formulation | factor | [%] | duration [h] |
| 15% of IR3535 ® | 1558 | 100 | 4.0 |
| 15% of Icaridin | 1761 | 113 | 5.0 |
| 15% of IR3535 ® + | 2167 | 139 | 5.5 |
| 15% of Icaridin | | | |

### Example 2

### Laboratory Test for Determination of the Efficacy Against Adult Biting Mosquitoes

### Test with Mice, Aedes aegypti and Anopheles stephensi

### 1. Purpose of the Study

The aim of this study is determination of the efficacy and action duration against biting mosquitoes of a formulation which comprises a repellent active-substance mixture.

The study is carried out with nude mice as host organisms.

### 2. Material and Method

Insects

The adult biting mosquitoes (Aedes aegypti and Anopheles stephensi) originate from a laboratory stock (strain: ORSTOM) which is known for reacting to active compounds from the insecticide group.

Method

The host organisms employed for the biting mosquitoes are nude mice. Each mouse is held in a net cylinder with eye protection. The mosquitoes can bite through the meshes of the net.

0.5 gram of the product to be tested is applied. The mouse is then placed in a glass cage measuring 50×50×50 cm. This cage contains at least 200 adult biting mosquitoes, with a particularly high proportion of females, which had not fed on blood for at least 2 days.

The mice are each left in the cage for 5 minutes. The following are recorded:
Number of bites
Number of landing attempts.

This procedure is repeated every 2 hours with fresh biting mosquitoes (T0, T2, T4, T6, T8, T10).

The test is ended at >5 bites for the respective mouse.

The positive control employed for determination of the “biting pressure” is untreated mice.

Three repetitions are carried out with 3 mice in each case, i.e. the tested product is tested a total of 9 times.

### 3. Tested Product

Alcoholic pump spray with the composition in % by weight:

| | |
|---|---|
| Alcohol denat. | 77.3% |
| Methylpropanediol | 12.0% |
| Ethyl butylacetylaminopropionate | 9.0% |
| Hydroxyethyl isobutyl piperidine carboxylate | 1.0% |
| Carapa guaianensis | 0.5% |
| Perfume (Lavendel ACS 38298) | 0.5% |

Ethyl butylacetylaminopropionate = IR3535 ®
Hydroxyethyl isobutyl piperidine carboxylate = icaridin

Primary data for Aedes aegypti: test duration for T0+x H(H=hours)

| | | | | | T0 + | | T0 + | | T0 + | | T0 + | | T0 + | |
|---|---|---|---|---|---|---|---|---|---|---|---|---|---|---|
| | | | T0 | | 2 H | | 4 H | | 6 H | | 8 H | | 10 H | |
| | Mouse | Rept. | B | L | B | L | B | L | B | L | B | L | B | L |
| Tested | 1 | 1 | 0 | 0 | 0 | 0 | 0 | 0 | 0 | 0 | 0 | 0 | stop | stop |
| product | | 2 | 0 | 0 | 0 | 0 | 0 | 0 | 0 | 0 | 0 | 1 | stop | stop |
| | | 3 | 0 | 0 | 0 | 0 | 0 | 0 | 0 | 0 | 0 | 0 | stop | stop |
| | 2 | 1 | 0 | 0 | 0 | 0 | 0 | 0 | 0 | 0 | 0 | 0 | stop | stop |
| | | 2 | 0 | 0 | 0 | 0 | 0 | 0 | 0 | 0 | 0 | 0 | stop | stop |
| | | 3 | 0 | 0 | 0 | 0 | 0 | 0 | 0 | 0 | 0 | 1 | stop | stop |
| | 3 | 1 | 0 | 0 | 0 | 0 | 0 | 0 | 0 | 0 | 0 | 1 | stop | stop |
| | | 2 | 0 | 0 | 0 | 0 | 0 | 0 | 0 | 0 | 0 | 0 | stop | stop |
| | | 3 | 0 | 0 | 0 | 0 | 0 | 0 | 0 | 0 | 0 | 1 | stop | stop |
| Untreated | 1 | 1 | stop | stop | stop | stop | stop | stop | stop | stop | stop | stop | stop | stop |
| positive | | 2 | stop | stop | stop | stop | stop | stop | stop | stop | stop | stop | stop | stop |
| control | | 3 | stop | stop | stop | stop | stop | stop | stop | stop | stop | stop | stop | stop |
| | 2 | 1 | stop | stop | stop | stop | stop | stop | stop | stop | stop | stop | stop | stop |
| | | 2 | stop | stop | stop | stop | stop | stop | stop | stop | stop | stop | stop | stop |
| | | 3 | stop | stop | stop | stop | stop | stop | stop | stop | stop | stop | stop | stop |
| | 3 | 1 | stop | stop | stop | stop | stop | stop | stop | stop | stop | stop | stop | stop |
| | | 2 | stop | stop | stop | stop | stop | stop | stop | stop | stop | stop | stop | stop |
| | | 3 | stop | stop | stop | stop | stop | stop | stop | stop | stop | stop | stop | stop |

B = bites,
L = landings,
Rept. = repetitions
Stop = the experiment is stopped at more than 5 bites.

Primary data for Anopheles stephensi: test duration (T0+X H) where H=hours

| | | | | | T0 + | | T0 + | | T0 + | | T0 + | | T0 + | |
|---|---|---|---|---|---|---|---|---|---|---|---|---|---|---|
| | | | T0 | | 2 H | | 4 H | | 6 H | | 8 H | | 10 H | |
| | Mouse | Rept. | B | L | B | L | B | L | B | L | B | L | B | L |
| Tested | 1 | 1 | 0 | 0 | 0 | 0 | 0 | 0 | 0 | 0 | 0 | 0 | stop | stop |
| product | | 2 | 0 | 0 | 0 | 0 | 0 | 0 | 0 | 0 | 0 | 0 | stop | stop |
| | | 3 | 0 | 0 | 0 | 0 | 0 | 0 | 0 | 0 | 0 | 0 | stop | stop |
| | 2 | 1 | 0 | 0 | 0 | 0 | 0 | 0 | 0 | 0 | 0 | 0 | stop | stop |
| | | 2 | 0 | 0 | 0 | 0 | 0 | 0 | 0 | 0 | 0 | 1 | stop | stop |
| | | 3 | 0 | 0 | 0 | 0 | 0 | 0 | 0 | 0 | 0 | 1 | stop | stop |
| | 3 | 1 | 0 | 0 | 0 | 0 | 0 | 0 | 0 | 0 | 0 | 1 | stop | stop |
| | | 2 | 0 | 0 | 0 | 0 | 0 | 0 | 0 | 0 | 0 | 0 | stop | stop |
| | | 3 | 0 | 0 | 0 | 0 | 0 | 0 | 0 | 0 | 0 | 1 | stop | stop |
| Untreated | 1 | 1 | stop | stop | stop | stop | stop | stop | stop | stop | stop | stop | stop | stop |
| positive | | 2 | stop | stop | stop | stop | stop | stop | stop | stop | stop | stop | stop | stop |
| control | | 3 | stop | stop | stop | stop | stop | stop | stop | stop | stop | stop | stop | stop |
| | 2 | 1 | stop | stop | stop | stop | stop | stop | stop | stop | stop | stop | stop | stop |
| | | 2 | stop | stop | stop | stop | stop | stop | stop | stop | stop | stop | stop | stop |
| | | 3 | stop | stop | stop | stop | stop | stop | stop | stop | stop | stop | stop | stop |
| | 3 | 1 | stop | stop | stop | stop | stop | stop | stop | stop | stop | stop | stop | stop |
| | | 2 | stop | stop | stop | stop | stop | stop | stop | stop | stop | stop | stop | stop |
| | | 3 | stop | stop | stop | stop | stop | stop | stop | stop | stop | stop | stop | stop |

B = bites,
L = landings,
Rept. = repetitions
Stop = the experiment is stopped at more than 5 bites.

### 4. Interpretation of the Results

The synergistic effect of ethyl butylacetylaminopropionate with icaridin in a weight percent ratio of 9:1 is confirmed by a protection duration of at least 8 hours since the following applies in comparison: ethyl butylacetylaminopropionate having a proportion of about 10% by weight in a formulation achieves protection times up to 4 hours. Icaridin is generally employed with a minimum of 10% by weight in a formulation in order to achieve protection times of about 4 hours.

### Example 3

### Liquid

| Ingredient (INCI) | [%] |
|---|---|
| A | |
| Ethyl 3-(acetylbutylamino)propionate | 25 |
| ICARIDIN | 5 |
| POLYSORBATE 80 | 0.20 |
| ACRYLATES/C10-30 ALKYL ACRYLATE | 0.20 |
| CROSSPOLYMER | |
| PERFUME | q.s. |
| B | |
| Ethanol 96% | 20.00 |
| AQUA (WATER) | to 100 |
| PROPYLENE GLYCOL | 10.00 |
| C | |
| SODIUM HYDROXIDE | q.s. |

### Preparation:

Phases A and B are mixed separately, and phase A is added to phase B with stirring. The pH is adjusted by means of phase C, and the mixture is homogenised.

### Example 4

### O/W After-Sun Lotion

| | |
|---|---|
| Ingredient (INCI) | [%] |

A

| | |
|---|---|
| Ethyl 3-(acetylbutylamino)propionate | 10.00 |
| ICARIDIN | 2 |
| BISABOLOL | 0.30 |
| CETEARYL ALCOHOL, CETEARYL | 4.00 |
| GLUCOSIDE | |
| CAPRYLIC/CAPRIC TRIGLYCERIDE | 2.00 |
| CYCLOPENTASILOXANE | 2.00 |
| DIMETHICONE | 1.00 |

B

| | |
|---|---|
| AQUA (WATER) | to 100 |
| GLYCERIN | 3.00 |
| Preservatives | q.s. |
| CITRIC ACID | 0.07 |
| DISODIUM PHOSPHATE | 0.59 |

C

| | |
|---|---|
| XANTHAN GUM | 0.50 |

### Preparation:

Phases A and B are heated separately to 75° C., phase C is slowly added to B, and the mixture is homogenised. A is subsequently added to B/C at 75° C., and the mixture is homogenised.

### Example 5

### Aqueous Gel

| | |
|---|---|
| Ingredient (INCI) | [%] |

A

| | |
|---|---|
| PROPYLENE GLYCOL | 5.00 |
| ALLANTOIN | 0.20 |
| AQUA (WATER) | to 100 |

B

| | |
|---|---|
| CARBOMER | 33.30 |

C

| | |
|---|---|
| Triethanolamine | 3.00 |

D

| | |
|---|---|
| Ethyl 3-(acetylbutylamino)propionate | 10.00 |
| ICARIDIN | 2 |

### Preparation:

Phase A is heated to 75° C. and slowly added to B. C is subsequently added to A/B, and the mixture is homogenised. D is then added.

### Example 6

### Spray

| | |
|---|---|
| Ingredient (INCI) | [%] |

A

| | |
|---|---|
| Ethyl 3-(acetylbutylamino)propionate | 20.00 |
| ICARIDIN | 3 |
| PEG-8 | 5.00 |
| PPG-15 STEARYL ETHER | 3.00 |
| PERFUME | 0.30 |

B

| | |
|---|---|
| ALCOHOL | 35.00 |
| PEG-32 | 4.00 |
| POLYSORBATE 20 | 1.50 |
| AQUA (WATER) | to 100 |

### Preparation:

Phase B is slowly added to A, and the mixture is homogenised.

### Example 7

### Roll-On

| | |
|---|---|
| Ingredient (INCI) | [%] |

A

| | |
|---|---|
| Ethyl 3-(acetylbutylamino)propionate | 20.00 |
| ICARIDIN | 2 |
| PEG-8 | 5.00 |
| PPG-15 STEARYL ETHER | 3.00 |
| PERFUME | 0.30 |

B

| | |
|---|---|
| ALCOHOL | 35.00 |
| PEG-32 | 4.00 |
| POLYSORBATE 20 | 1.50 |
| CARBOMER | 10.00 |
| AQUA (WATER) | to 100 |

C

| | |
|---|---|
| TRIETHANOLAMINE | 0.30 |

### Preparation:

Phases A and B are mixed separately, and phase B is added to phase A with stirring. The pH is adjusted by means of phase C, and the mixture is subsequently homogenised.

### Example 8

### Cream

| | |
|---|---|
| Ingredient (INCI) | [%] |

A

| | |
|---|---|
| Ethyl 3-(acetylbutylamino)propionate | 20.00 |
| ICARIDIN | 1 |
| CETEARYL ALCOHOL, CETEARYL GLUCOSIDE | 4.00 |
| CARBOMER | 0.25 |

B

| | |
|---|---|
| Preservatives | q.s. |
| GLYCERIN | 3.00 |
| XANTHAN GUM | 0.50 |
| AQUA (WATER) | to 100 |

C

| | |
|---|---|
| TRIETHANOLAMINE | q.s. |

### Preparation:

Phases A and B are heated to 70° C., and A is slowly added to B. The pH is adjusted by means of phase C, and the mixture is subsequently homogenised.

### Example 9

### Cream

| | |
|---|---|
| Ingredient (INCI) | [%] |

A

| | |
|---|---|
| Ethyl 3-(acetylbutylamino)propionate | 20.00 |
| ICARIDIN | 2 |
| CETEARYL ALCOHOL, CETEARYL GLUCOSIDE | 4.00 |
| CARBOMER | 0.40 |
| OLEYL ERUCATE | 1.00 |
| CYCLOPENTASILOXANE | 1.00 |
| DIBUTYL ADIPATE | 1.00 |
| ISOPROPYL PALMITATE | 1.00 |

B

| | |
|---|---|
| GLYCERIN | 3.00 |
| XANTHAN GUM | 0.20 |
| Preservatives | q.s. |
| AQUA (WATER) | to 100 |

C

| | |
|---|---|
| TRIETHANOLAMINE | q.s. |

### Preparation:

Phases A and B are heated to 70° C., and A is slowly added to B. The pH is adjusted by means of phase C, and the mixture is subsequently homogenised.

### Example 10

### Camouflage Paint

| | |
|---|---|
| Ingredient (INCI) | [%] |

A

| | |
|---|---|
| CI 77499 (IRON OXIDES), MICA | 15.00 |
| TALC | 15.00 |

B

| | |
|---|---|
| C18-36 ACID TRIGLYCERIDE | 12.00 |
| TRIBEHENIN | 3.00 |
| CAPRYLIC/CAPRIC TRIGLYCERIDE | 7.00 |
| STEARIC ACID | 3.00 |
| PEG-8, TOCOPHEROL, ASCORBYL | 0.10 |
| PALMITATE, ASCORBIC ACID, CITRIC ACID | |
| Preservatives | q.s. |
| PPG-2 MYRISTYL ETHER PROPIONATE | to 100 |
| Ethyl 3-(acetylbutylamino)propionate | 20.00 |
| ICARIDIN | 2 |

### Preparation:

Phase A is mixed and slowly added to phase B heated to 80° C.

### Example 11

### Sunscreen

### SPF: 43.6

| | |
|---|---|
| Ingredient (INCI) | [%] |

A

| | |
|---|---|
| Ethyl 3-(acetylbutylamino)propionate | 10.00 |
| ICARIDIN | 2 |
| TOCOPHERYL ACETATE | 0.25 |
| ETHYLHEXYL METHOXYCINNAMATE, BHT | 7.50 |
| OCTOCRYLENE | 10.00 |
| BUTYL METHOXYDIBENZOYLMETHANE | 0.90 |
| BENZOPHENONE-3 | 1.10 |
| GLYCERYL STEARATE, PEG-100 STEARATE | 3.20 |
| COCO-GLUCOSIDE, COCONUT ALCOHOL | 1.30 |
| DIBUTYL ADIPATE | 3.00 |

B

| | |
|---|---|
| LAURETH-7, POLYACRYLAMIDE, C13-14-ISOPARAFFIN | 1.20 |
| Cyclopentasiloxane | 5.00 |

C

| | |
|---|---|
| GLYCERIN | 7.00 |
| XANTHAN GUM | 0.15 |
| MAGNESIUM ALUMINUM SILICATE | 0.60 |
| DISODIUM EDTA | 0.10 |
| AQUA (WATER) | to 100 |

D

| | |
|---|---|
| Preservatives | q.s. |
| PERFUME | 0.20 |

E

| | |
|---|---|
| TROMETHAMINE | q.s. |

### Preparation:

All phases are prepared separately. Phase C: Xanthan Gum and Magnesium Aluminium Silicate are heated to 75-80° C. and mixed with the other constituents. Phase A is added to phase C at 75° C. After homogenisation, phase B is added at 60° C. After homogenisation, phase D is added at 40° C. Phase E is then added (pH=6.5).

### Example 12

### Sunscreen

### SPF: 28.3

| | |
|---|---|
| Ingredient (INCI) | [%] |

A

| | |
|---|---|
| PROPYLENE GLYCOL | 2.00 |
| AQUA (WATER) | to 100 |
| CARBOMER | 0.30 |

B

| | |
|---|---|
| Ethyl 3-(acetylbutylamino)propionate | 10.00 |
| ICARIDIN | 1 |
| GLYCERYL STEARATE, PEG-100 STEARATE | 2.00 |
| BENZOPHENONE-3 | 5.00 |
| ETHYLHEXYL SALICYLATE | 5.00 |
| ETHYLHEXYL METHOXYCINNAMATE, BHT | 10.00 |
| 4-METHYLBENZYLIDENE CAMPHOR | 2.00 |
| ISOPROPYL PALMITATE | 1.00 |
| CETYL PEG/PPG-10/1 DIMETHICONE | 2.00 |
| CYCLOPENTASILOXANE | 1.00 |
| TRIMETHYLSILOXYSILICATE, DIMETHICONE | 1.00 |

C

| | |
|---|---|
| Preservatives | q.s. |
| PERFUME | q.s. |
| TRIETHANOLAMINE | 0.30 |

### Preparation:

Phases A and B are heated to 75° C., and B is slowly added to A. Phase C is added at 40° C., and the mixture is subsequently homogenised.

### Example 13

### Sunscreen

### SPF: 28.3

| | |
|---|---|
| Ingredient (INCI) | [%] |

A

| | |
|---|---|
| PROPYLENE GLYCOL | 2.00 |
| AQUA (WATER) | to 100 |
| CARBOMER | 0.30 |

B

| | |
|---|---|
| Ethyl 3-(acetylbutylamino)propionate | 10.00 |
| ICARIDIN | 1.50 |
| GLYCERYL STEARATE, PEG-100 STEARATE | 2.00 |
| BENZOPHENONE-3 | 5.00 |
| ETHYLHEXYL SALICYLATE | 5.00 |
| ETHYLHEXYL METHOXYCINNAMATE, BHT | 10.00 |
| 4-METHYLBENZYLIDENE CAMPHOR | 2.00 |
| ISOPROPYL PALMITATE | 1.00 |
| CETYL PEG/PPG-10/1 DIMETHICONE | 2.00 |
| CYCLOPENTASILOXANE | 1.00 |
| TRIMETHYLSILOXYSILICATE, DIMETHICONE | 1.00 |

C

| | |
|---|---|
| Preservatives | q.s. |
| PERFUME | q.s. |
| TRIETHANOLAMINE | 0.30 |

### Preparation:

Phases A and B are heated to 75° C., and B is slowly added to A. Phase C is added at 40° C., and the mixture is subsequently homogenised.

### Example 14

### Spray

| | |
|---|---|
| Ingredient (INCI) | [%] |

A

| | |
|---|---|
| Ethyl 3-(acetylbutylamino)propionate | 10.00 |
| ICARIDIN | 1.00 |
| BENZOPHENONE-3 | 1.50 |
| ETHYLHEXYL METHOXYCINNAMATE, BHT | 3.50 |
| DICAPRYLYL CARBONATE | 0.50 |
| DECYL OLEATE | 0.25 |
| POLYGLYCERYL-3 METHYLGLUCOSE DISTEARATE | 1.00 |
| ISOPROPYL PALMITATE | 0.50 |

B

| | |
|---|---|
| AQUA (WATER) | to 100 |
| GLYCERIN | 3.00 |
| Preservatives | q.s. |
| CARBOMER | 0.10 |
| SODIUM HYDROXIDE | 0.25 |

C

| | |
|---|---|
| PERFUME | 0.20 |

### Preparation:

Phases A and B are heated to 80° C., and A is slowly added to B. Phase C is added at 40° C., and the mixture is subsequently homogenised.

### Example 15

### Spray

| | |
|---|---|
| Ingredient (INCI) | [%] |

A

| | |
|---|---|
| Ethyl 3-(acetylbutylamino)propionate | 25.00 |
| ICARIDIN | 4 |
| STEARETH-21 | 2.50 |
| Arlatone 985 | 5.00 |
| PARAFFINUM LIQUIDUM (MINERAL OIL) | 5.00 |
| DIMETHICONE | 1.00 |
| MYRISTYL ALCOHOL | 4.00 |

B

| | |
|---|---|
| AQUA (WATER) | to 100 |
| GLYCERIN | 3.00 |
| CARBOMER | 1.00 |

C

| | |
|---|---|
| Preservatives | q.s. |

D

| | |
|---|---|
| TROMETHAMINE | 0.10 |
| AQUA (WATER) | 1.00 |

### Preparation:

Phase A is heated to 75° C. and slowly added to B. C is subsequently added to A/B, and the mixture is homogenised. D is then added in order to set the pH.

### Example 16

### Spray

| | |
|---|---|
| Ingredient (INCI) | [%] |

A

| | |
|---|---|
| Ethyl 3-(acetylbutylamino)propionate | 22.50 |
| ICARIDIN | 2.50 |
| STEARETH-21 | 2.00 |
| Arlatone 985 | 4.00 |
| PARAFFINUM LIQUIDUM (MINERAL OIL) | 7.50 |
| DIMETHICONE | 1.00 |
| MYRISTYL ALCOHOL | 4.00 |

B

| | |
|---|---|
| AQUA (WATER) | to 100 |
| GLYCERIN | 3.00 |
| CARBOMER | 0.10 |

C

| | |
|---|---|
| Preservatives | q.s. |

D

| | |
|---|---|
| TROMETHAMINE | 0.15 |
| AQUA (WATER) | 1.50 |

### Preparation:

Phase A is heated to 75° C. and slowly added to B. C is subsequently added to A/B, and the mixture is homogenised. D is then added in order to set the pH.

### Example 17

### Emulsion

| | |
|---|---|
| Ingredient (INCI) | [%] |

A

| | |
|---|---|
| Ethyl 3-(acetylbutylamino)propionate | 25.00 |
| ICARIDIN | 3.50 |
| MYRISTYL ALCOHOL, MYRISTYL GLUCOSIDE | 5.00 |
| ISOSTEARYL ISOSTEARATE | 2.00 |
| CETYL ALCOHOL | 2.00 |

B

| | |
|---|---|
| AQUA (WATER) | to 100 |
| CARBOMER | 0.40 |

C

| | |
|---|---|
| SODIUM HYDROXIDE | q.s. |

D

| | |
|---|---|
| Preservatives | q.s. |
| PERFUME | q.s. |

### Preparation:

Phase A is heated to 80° C. and slowly added to B (75° C.). C is subsequently added to A/B, and the mixture is homogenised. D is then added.

### Example 18

### O/W After-Sun Lotion

| | |
|---|---|
| Ingredient (INCI) | [%] |

A

| | |
|---|---|
| Ethyl 3-(acetylbutylamino)propionate | 10.00 |
| ICARIDIN | 2 |
| BISABOLOL | 0.30 |
| CETEARYL ALCOHOL, CETEARYL | 4.00 |
| GLUCOSIDE | |
| CAPRYLIC/CAPRIC TRIGLYCERIDE | 2.00 |
| CYCLOPENTASILOXANE | 2.00 |
| DIMETHICONE | 1.00 |

B

| | |
|---|---|
| AQUA (WATER) | to 100 |
| GLYCERIN | 3.00 |
| Preservatives | q.s. |

C

| | |
|---|---|
| XANTHAN GUM | 0.50 |

### Preparation:

Phases A and B are heated separately to 75° C., phase C is slowly added to B, and the mixture is homogenised. A is subsequently added to B/C at 75° C., and the mixture is homogenised.

1. A method comprising using an insect repellent as action enhancer for at least one second insect repellent.

2. A method according to claim 1, characterised in that the action enhancer is an insect repellent selected from the group 2-(2-hydroxyethyl)-1-methylpropyl 1-piperidinecarboxylate, N,N-diethyl-3-methylbenzamide, dimethyl phthalate, butopyronoxyl, 2,3,4,5-bis(2-butylene)tetrahydro-2-furaldehyde, N,N-diethylcaprylamide, N,N-diethylbenzamide, o-chloro-N,N-diethylbenzamide, dimethyl carbate, di-n-propyl isocinchomeronate, 2-ethylhexane-1,3-diol, N-octylbicycloheptenedicarboximide or piperonyl butoxide.

3. A method according to claim 1, characterised in that the action enhancer is 2-(2-hydroxyethyl)-1-methylpropyl 1-piperidinecarboxylate.

4. A method according to claim 1, characterised in that the at least second insect repellent is selected, depending on the action enhancer, from the compounds of the formula I 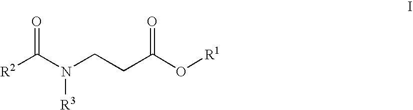
where R¹, R² and R³ may be identical or different and are selected from
straight-chain or branched C₁- to C₂₄-alkyl groups,
straight-chain or branched C₃- to C₂₄-alkenyl groups,
straight-chain or branched C₁- to C₂₄-hydroxyalkyl groups, where the hydroxyl group may be bonded to a primary or secondary carbon atom of the chain and furthermore the alkyl chain may also be interrupted by oxygen, and/or
C₃- to C₁₀-cycloalkyl groups and/or C₃- to C₁₂-cycloalkenyl groups, where the rings may in each case also be bridged by —(CH₂)ₙ— groups, where n=1 to 3, or from the compounds N,N-diethyl-3-methylbenzamide, dimethyl phthalate, butopyronoxyl, 2,3,4,5-bis(2-butylene)tetrahydro-2-furaldehyde, N,N-diethylcaprylamide, N,N-diethylbenzamide, o-chloro-N,N-diethylbenzamide, dimethyl carbate, di-n-propyl isocinchomeronate, 2-ethylhexane-1,3-diol, N-octylbicycloheptenedicarboximide, piperonyl butoxide, 2-(2-hydroxyethyl)-1-methylpropyl 1-piperidinecarboxylate or mixtures thereof.

5. A method according to claim 1, where the at least second insect repellent is selected from N,N-diethyl-3-methylbenzamide, ethyl 3-(acetylbutylamino)propionate or mixtures thereof.

6. A method according to claim 1, characterised in that, in the insect repellent of the formula I, R¹ and R³ may be identical or different and are selected from ethyl, n-propyl, isopropyl, n-butyl, isobutyl, tert-butyl, n-pentyl, n-hexyl, n-heptyl, n-octyl, 2-ethylhexyl, n-decyl, n-dodecyl, n-tetradecane, n-hexadecane, n-octadecane, n-eicosane, n-docosane or n-tetracosane.

7. A method according to claim 1, characterised in that, in the insect repellent of the formula I, R² is selected from the group comprising the elements methyl, n-propyl, isopropyl, n-pentyl, n-heptyl, 1-ethylpentyl, n-nonyl, n-undecyl.

8. A method according to claim 1, characterised in that the compound of the formula I is selected from the compounds ethyl N-acetyl-N-(2-ethylhexyl)-3-aminopropanoate, ethyl N-acetyl-N-(dodecyl)-3-aminopropanoate, ethyl N-(2-ethylhexoyl)-N-(butyl)-3-aminopropanoate, butyl N-acetyl-N-(butyl)-3-aminopropanoate, ethyl N-(2-ethylhexoyl)-N-(2-ethylhexyl)-3-aminopropanoate, ethyl N-(2-ethylhexoyl)-N-(dodecyl)-3-aminopropanoate, butyl N-acetyl-N-(2-ethylhexyl)-3-aminopropanoate, butyl N-acetyl-N-(dodecyl)-3-aminopropanoate, butyl N-(2-ethylhexoyl)-N-(butyl)-3-aminopropanoate, butyl N-(2-ethylhexoyl)-N-(2-ethylhexyl)-3-aminopropanoate, butyl N-(2-ethylhexoyl)-N-(dodecyl)-3-aminopropanoate, 2-ethylhexyl N-acetyl-N-(butyl)-3-aminopropanoate, 2-ethylhexyl N-acetyl-N-(2-ethylhexyl)-3-aminopropanoate, 2-ethylhexyl N-acetyl-N-(dodecyl)-3-aminopropanoate, 2-ethylhexyl N-(2-ethylhexoyl)-N-(butyl)-3-aminopropanoate, 2-ethylhexyl N-(2-ethylhexoyl)-N-(2-ethylhexyl)-3-aminopropanoate or 2-ethylhexyl N-(2-ethylhexoyl)-N-(dodecyl)-3-aminopropanoate.

9. A method according to claim 1, characterised in that the at least second insect repellent is ethyl 3-(acetylbutylamino)-propionate.

10. A method according to claim 1, characterised in that the insect repellent of the formula I is ethyl N-acetyl-N-(2-ethylhexyl)-3-aminopropanonate.

11. Composition comprising 0.1 to 20% by weight of an insect repellent as action enhancer and 1 to 60% by weight of at least one second insect repellent, where the weight percent ratio of the at least second insect repellent to the action enhancer is in the range from 20:1 to 1:1.

12. Composition according to claim 11, characterised in that the insect repellent as action enhancer is selected from the group 2-(2-hydroxyethyl)-1-methylpropyl 1-piperidinecarboxylate, dimethyl phthalate, butopyronoxyl, 2,3,4,5-bis(2-butylene)tetrahydro-2-furaldehyde, N,N-diethylcaprylamide, N,N-diethylbenzamide, o-chloro-N,N-diethylbenzamide, dimethyl carbate, di-n-propyl isocinchomeronate, 2-ethylhexane-1,3-diol, N-octylbicycloheptenedicarboximide or piperonyl butoxide.

13. Composition according to claim 11, characterised in that the action enhancer is 2-(2-hydroxyethyl)-1-methylpropyl 1-piperidinecarboxylate.

14. Composition according to claim 11, characterised in that the at least second insect repellent is selected, depending on the action enhancer, from the compounds of the formula I 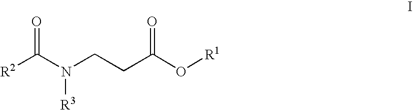
where R¹, R² and R³ may be identical or different and are selected from
straight-chain or branched C₁- to C₂₄-alkyl groups,
straight-chain or branched C₃- to C₂₄-alkenyl groups,
straight-chain or branched C₁- to C₂₄-hydroxyalkyl groups, where the hydroxyl group may be bonded to a primary or secondary carbon atom of the chain and furthermore the alkyl chain may also be interrupted by oxygen, and/or
C₃- to C₁₀-cycloalkyl groups and/or C₃- to C₁₂-cycloalkenyl groups, where the rings may in each case also be bridged by —(CH₂)ₙ— groups, where n=1 to 3,
or selected from the compounds N,N-diethyl-3-methylbenzamide, dimethyl phthalate, butopyronoxyl, 2,3,4,5-bis(2-butylene)tetrahydro-2-furaldehyde, N,N-diethylcaprylamide, N,N-diethylbenzamide, o-chloro-N,N-diethylbenzamide, dimethyl carbate, di-n-propyl iso-cinchomeronate, 2-ethylhexane-1,3-diol, N-octylbicycloheptenedicarboximide, piperonyl butoxide or mixtures thereof.

15. Composition according to claim 11, characterised in that the second insect repellent is selected from N,N-diethyl-3-methylbenzamide, ethyl 3-(acetylbutylamino)propionate or mixtures thereof.

16. Composition according to claim 11, characterised in that, in the insect repellent of the formula I, R¹ and R³ may be identical or different and are selected from ethyl, n-propyl, isopropyl, n-butyl, isobutyl, tert-butyl, n-pentyl, n-hexyl, n-heptyl, n-octyl, 2-ethylhexyl, n-decyl, n-dodecyl, n-tetradecane, n-hexadecane, n-octadecane, n-eicosane, n-docosane or n-tetracosane.

17. Composition according to claim 11, characterised in that, in the insect repellent of the formula I, R² is selected from the group comprising the elements methyl, n-propyl, isopropyl, n-pentyl, n-heptyl, 1-ethylpentyl, n-nonyl, n-undecyl.

18. Composition according to claim 11, characterised in that the compound of the formula I is selected from the compounds ethyl N-acetyl-N-(2-ethylhexyl)-3-aminopropanoate, ethyl N-acetyl-N-(dodecyl)-3-aminopropanoate, ethyl N-(2-ethylhexoyl)-N-(butyl)-3-aminopropanoate, butyl N-acetyl-N-(butyl)-3-aminopropanoate, ethyl N-(2-ethylhexoyl)-N-(2-ethylhexyl)-3-aminopropanoate, ethyl N-(2-ethylhexoyl)-N-(dodecyl)-3-aminopropanoate, butyl N-acetyl-N-(2-ethylhexyl)-3-aminopropanoate, butyl N-acetyl-N-(dodecyl)-3-aminopropanoate, butyl N-(2-ethylhexoyl)-N-(butyl)-3-aminopropanoate, butyl N-(2-ethylhexoyl)-N-(2-ethylhexyl)-3-aminopropanoate, butyl N-(2-ethylhexoyl)-N-(dodecyl)-3-aminopropanoate, 2-ethylhexyl N-acetyl-N-(butyl)-3-aminopropanoate, 2-ethylhexyl N-acetyl-N-(2-ethylhexyl)-3-aminopropanoate, 2-ethylhexyl N-acetyl-N-(dodecyl)-3-aminopropanoate, 2-ethylhexyl N-(2-ethylhexoyl)-N-(butyl)-3-aminopropanoate, 2-ethylhexyl N-(2-ethylhexoyl)-N-(2-ethylhexyl)-3-aminopropanoate or 2-ethylhexyl N-(2-ethylhexoyl)-N-(dodecyl)-3-aminopropanoate.

19. Composition according to claim 11, characterised in that the insect repellent of the formula I is ethyl 3-(acetylbutylamino)propionate.

20. Composition according to claim 11, characterised in that the insect repellent of the formula I is ethyl N-acetyl-N-(2-ethylhexyl)-3-aminopropanoate.

21. Composition according to claim 11, characterised in that the weight percent ratio of the at least second insect repellent to the insect repellent as action enhancer is in the range from 10:1 to 5:1.

22. Composition according to claim 11, characterised in that the weight percent ratio of the at least second insect repellent to the insect repellent as action enhancer is 1:1.

23. Composition according to claim 11, characterised in that the weight percent ratio of the at least second insect repellent to the insect repellent as action enhancer is 9:1, 5:1 and/or 1:1.

24. Composition according to claim 11, characterised in that at least one cosmetically or dermatologically tolerated vehicle is present.

25. Composition according to claim 11 for the protection of body cells against oxidative stress, characterised in that it comprises one or more antioxidants and/or vitamins.

26. Composition according to claim 11, where the composition comprises one or more UV filters, which are preferably selected from the group comprising 3-(4′-methylbenzylidene)-dl-camphor, 1-(4-tert-butylphenyl)-3-(4-methoxyphenyl)propane-1,3-dione, 4-isopropyldibenzoylmethane, 2-hydroxy-4-methoxybenzophenone, octyl methoxycinnamate, 3,3,5-trimethylcyclohexyl salicylate, 2-ethylhexyl 4-(dimethylamino)benzoate, 2-ethylhexyl 2-cyano-3,3-diphenylacrylate, 2-phenylbenzimidazole-5-sulfonic acid and the potassium, sodium and triethanolamine salts thereof.

27. Process for the preparation of a composition according to claim 11, characterised in that an insect repellent as action enhancer and at least one second insect repellent are mixed with a cosmetically or dermatologically suitable vehicle.
